(19) United States
(12) Patent Application Publication
(10) Pub. No.: US 2005/0129440 A1
(43) Pub. Date: Jun. 16, 2005

(54) Information processing apparatus and transportation path opening/closing mechanism

(76) Inventors: Norio Nagata, Matsumoto-shi (JP); Hideki Furihata, Okaya-shi (JP)

Correspondence Address: ANDERSON, KILL & OLICK, P.C., 1251 AVENUE OF THE AMERICAS, NEW YORK,, NY, 10020-1182, US

(21) Appl. No.: 10/989,320

(22) Filed: Nov. 15, 2004

(30) Foreign Application Priority Data
Nov. 14, 2003 (JP) 2003-385407
Mar. 15, 2004 (JP) 2004-072680
Mar. 15, 2004 (JP) 2004-072681
Apr. 1, 2004 (JP) 2004-109220
May 13, 2004 (JP) 2004-143969

(51) Int. Cl. G03G 15/00

(52) U.S. Cl. 399/405

(57) ABSTRACT

An information processing apparatus and transportation path opening/closing mechanism for removing a paper jam with ease even when the paper jam occurs where a data reader is disposed to the transportation path. A first scanner for imaging one side of a first or second transported medium is disposed to the outside guide wall side of the transportation path. A first pressure mechanism for pressing the first or second transported medium to the scanning surface of the first scanner is located opposite the first scanner on the inside guide wall side of the transportation path. A second scanner for imaging the other side of the first or second transported medium is located on the inside guide wall side of the transportation path. A second pressure mechanism for pressing the first or second transported medium to the second scanner is located opposite the second scanner on the outside guide wall side of the transportation path. The first scanner and second pressure mechanism are incorporated within an opening/closing wall section of the transportation path opening/closing mechanism that opens and closes by pivoting on a pivot joint. A mechanism for reducing or removing the holding force of the transportation rollers when the opening/closing wall opens is disposed for the transportation roller pairs located near this opening/closing wall.

### BACKGROUND OF THE INVENTION

1. Field of the Invention

The present invention relates to an information processing apparatus for reading information recorded on a transported medium such as a check while conveying the transported medium along a transportation path. The invention also relates to a transportation path opening/closing mechanism for opening a portion of the transportation path to access.

2. Description of Related Art

In order to improve the efficiency of check processing, some banks and financial institutions have begun to electronically scan and read the checks for on-line processing and settlement. This has led to the development of information processing apparatuses such as taught in Japanese Unexamined Patent Application 2000-344428. While conveying a transported medium such as a check or other pliable medium, this information processing apparatus reads information from the transported medium using a scanner, MICR, or other information reading unit, and prints information to the transported medium using a printer or other data recording unit.

A U-shaped transportation path renders the entrance and exit portions of the transportation path in proximity on the same side of the information processing apparatus, and thus enables the operator to easily insert and remove the transported medium to and from the transportation path.

A U-shaped transportation path also provides a long transportation path within a short span, thereby allowing a plurality of information processing means such as data readers and data recorders to be disposed along the transportation path. A compact, hybrid information processing apparatus can therefore be provided.

FIG. 32 is an oblique view of an image reading apparatus (information reading apparatus) 401 having a U-shaped transportation path 403. A scanner or other image reader is disposed to an image scanning area 404 of the transportation path 403.

When a check or other transported medium 402 is conveyed through the transportation path 403 and passes the image scanning area 404, the image reader captures an image of one side (the front in this example) of the transported medium 402. A plurality of transportation rollers (not shown) for conveying the transported medium 402 are disposed along the transportation path 403 at intervals appropriate to the length of the transported medium 402.

The image reader used in the image reading apparatus 401 must be capable of reading an area at least covering the entire height K of the tallest transported medium 402 that will be conveyed through the transportation path. The height (effective reading area) of the image reader is therefore greater than the height K of the transported medium 402.

A means for pressing the transported medium 402 to the scanning surface of the image reader must also be provided at a position opposite the scanning surface of the image reader. The height of this pressure means must also be greater than the height K of the transported medium 402.

As shown in FIG. 32, the image scanning area 404 is therefore a structure that is taller than the height K of the transported medium 402, and has the scanning surface of the image reader and the pressure means on opposing faces of a pair of guide walls 404a, 404b located on opposite sides of the transportation path 403.

As a result, when a transported medium 402 becomes jammed inside the image scanning area 404, the jammed transported medium 402 is hidden between the pair of guide walls 404a, 404b, and cannot be easily grasped from outside the transportation path 403. Removing the jammed transported medium 402 from the image scanning area 404 is therefore quite difficult, and may require calling a trained repair technician that can disassemble and repair the image reading apparatus 401.

Disassembly is also required to clean the scanning surface of the image reader when the scanning surface of the image reader becomes soiled, and cleaning is thus difficult.

A plurality of transportation roller pairs each having a rotationally driven transportation roller and a pressure roller for pressing the transported medium 402 to the transportation roller is also disposed to the transportation path. When the transportation roller pairs hold the transported medium with too much force and a jammed transported medium 402 is forcibly removed from between the transportation roller pair, the transported medium 402 may be torn. When the transported medium 402 is a check or other negotiable instrument, preventing such damage to the transported medium becomes very important.

A particular problem with a U-shaped transportation path 403 is that paper jams occur easily in the curved portion of the transportation path. In addition, multiple transportation rollers are disposed in proximity to each other in this curved portion. As a result, when a paper jam occurs in the curved portion, the conveyed medium is held by a plurality of transportation rollers, making recovery from a paper jam more difficult.

Paper clips and other foreign objects can also fall into the transportation path 403 from the top opening 404c to the image scanning area 404, and removing such foreign objects from the image scanning area 404 is difficult. In addition, if a foreign object has fallen into the transportation path 403 and a check or other transported medium 402 is then conveyed through the transportation path 403, the foreign object could cause a paper jam or damage to the scanning surface of the image reader.

To assure that the gap between the top and bottom portions of the pair of guide walls 404a, 404b, that is, the width of the transportation path 403, is held within a specified dimensional range and tolerance, the material used for the guide walls 404a, 404b must have a certain rigidity. Using such materials tends to increase the overall weight and cost of the apparatus. More particularly, when the transportation path is constructed so that these guide walls 404a, 404b can be opened and closed in order to facilitate removing the transported medium when a paper jam occurs or to clean the scanning surface of the image reader, maintaining the width of the transportation path within the specified tolerance range is particularly important.

In accordance with the present invention the information processing apparatus is provided with a transportation path opening/closing mechanism enabling easy access to a jammed transported medium without disassembling the image reading apparatus, thus enabling easily removing a transported medium without damaging the medium, and easily cleaning inside the transportation path.

The information processing apparatus further includes a transportation path opening/closing mechanism that prevent foreign objects from accidentally entering a specific portion of the transportation path from outside, and maintain the dimensional tolerance at the top and bottom portions of the transportation path within a specified range.

### SUMMARY OF THE INVENTION

The information processing apparatus of the present invention includes a U-shaped transportation path for conveying a first transported medium; a data reader for reading information recorded to the first transported medium conveyed on the U-shaped transportation path; and a transportation path opening/closing mechanism for opening a portion of the U-shaped transportation path in the area where the data reader is disposed to the U-shaped transportation path.

If the transported medium jams in the part of the transportation path where the data reader is located, the transportation path opening/closing mechanism may be opened to expose the transportation path at such location to provide access to the transported medium. The transported medium that jammed in the transportation path can thus be easily removed because the inside of the transportation path is exposed and accessible.

This information processing apparatus preferably also has a straight transportation path for conveying a second transported medium for reading information recorded on the second transported medium by means of the data reader. This straight transportation path includes the straight portion of the U-shaped transportation path containing the area where the data reader and transportation path opening/closing mechanism are disposed, and a linear transportation path connected in line with said straight portion.

This aspect of the invention enables reading not only pliable first transported media such as checks and other slips, but also stiff second transported media such as driver licenses and other cards that do not bend so easily.

Yet further preferably, the U-shaped transportation path has an outside guide wall and an inside guide wall for guiding the first or second transported medium on both sides of the transported medium, and the transportation path opening/closing mechanism has an opening/closing wall that can open and close to at least one of the outside and inside guide walls.

Further preferably, the opening/closing wall is attached by a pivot joint within the information processing apparatus, to enable it to open and close by rotating on this pivot joint.

By thus enabling the opening/closing wall to swing open and closed on a pivot joint, the transportation path can be exposed at a desired location to provide access to a transportation medium by means of a simple mechanism.

Yet further preferably, the data reader or a pressure mechanism for pressing the first or second transported medium to the scanning surface of the data reader is incorporated within the opening/closing wall.

Yet further preferably, at least one transportation roller pair for conveying the first or second transported medium holds the first or second transported medium even when the U-shaped transportation path is exposed.

The transported medium can thus be prevented from dropping and being damaged when the transportation path is exposed because at least one transportation roller pair holds the transported medium that jammed in the transportation path even when the transportation path is exposed for access.

Yet further preferably, the information processing apparatus also has a first data reader disposed on the outside guide wall side of the transportation path for reading information on one side of the first or second transported medium; a first pressure mechanism disposed on the inside guide wall side opposite the first data reader for pressing the first or second transported medium to the scanning surface of the first data reader; a second data reader disposed on the inside guide wall side of the transportation path for reading information on the other side of the first or second transported medium; and a second pressure mechanism disposed on the outside guide wall side opposite the second data reader for pressing the first or second transported medium to the scanning surface of the second data reader. In addition, the first data reader and the second pressure mechanism are also preferably incorporated within the opening/closing wall.

Both sides of the transported medium can thus be read using two data readers while the transportation path can also be opened for access by means of a simple mechanism.

An information processing apparatus according to another aspect of the invention has a transportation path for conveying a transported medium standing lengthwise on edge along a horizontal surface with the top portion of the transportation path open to the outside; a data reader disposed to the transportation path for reading information on the transported medium conveyed through the transportation path; and a cover member for covering at least part of said top opening to the transportation path in the area where the data reader is disposed to the transportation path.

Foreign objects are thus prevented from falling into the transportation path in the neighborhood of the data reader. This eliminates the need to remove such foreign objects from the transportation path, and prevents damage to the data reader by such foreign objects.

Preferably, the transportation path in this information reading apparatus has a portion wherein the transported medium is conveyed with a part of the transported medium exposed from the transportation path, and a portion wherein the entire transported medium is covered; and the cover member covers at least a portion of said top opening to the transportation path in the area where the transported medium is completely covered.

By thus conveying the transported medium with part of the medium exposed from the transportation path, this aspect of the invention reduces device size and weight, and improves operability and cost efficiency. In this case the part of the transportation path where the transported medium is exposed above the transportation path is not covered by the cover member.

Further preferably, the transportation path is formed in a U-shape resulting in the transported medium being conveyed in substantially opposite directions at the insertion opening and discharge opening.

This configuration affords a long transportation path within a small area, and reduces the size and weight of the device even when multiple functional components are disposed along the transportation path.

Yet further preferably, the cover member is fastened to the inside guide wall and outside guide wall of the transportation path, and holds a gap between said guide walls to a specific width.

By thus fastening the cover member to both guide walls of the transportation path, the rigidity of the cover member maintains a specific gap inside the transportation path, that is, between the guide walls. The rigidity of the cover member only needs to be sufficient to hold this transportation path gap to within a specified range. The cover member is therefore not limited to metal, and can be made of plastic or other lightweight material. Furthermore, because a necessary specific dimensional tolerance can be maintained by the cover member even if the rigidity of the guide walls is low, plastic materials can be used for the guide walls even when the guide walls are tall.

Further preferably, the cover member engages engagement pins disposed to one of the guide walls, and is fastened by screw to the other guide wall.

By thus securing one side of the cover member with pins, disassembly and maintenance are simplified while maintaining the necessary precision.

Yet further preferably, the information processing apparatus also has a transportation path opening/closing mechanism disposed to the area where the data reader is disposed to the transportation path for opening/closing a portion of the transportation path, and the cover member covers at least the top opening in the transportation path opening/closing mechanism.

Yet further preferably, the cover member has a positioning groove controlling the closed position of the transportation path opening/closing mechanism; and the transportation path opening/closing mechanism engages the positioning groove in the closed position to control the closed position of the transportation path opening/closing mechanism.

By thus providing a positioning groove in the cover member to engage the transportation path opening/closing mechanism, the necessary dimensional tolerance of the transportation path can be maintained within a specified range even when a transportation path opening/closing mechanism is rendered to the transportation path for opening and accessing the transportation path.

Yet further preferably, the data reader includes one or both of an image scanner for imaging the transported medium, and a magnetic ink character reader for reading magnetic ink characters on the transported medium.

Further preferably, a data recording unit is disposed to a portion of the transportation path for recording information to the transported medium.

When such data readers and data recorders are thus also provided, multiple processes can be executed in a single pass of the transported medium through the transportation path. If the transported medium is a check, for example, the check can be imaged and read, and a transaction record can be printed to the front or back of the check. Data processing apparatuses of this type are also usually located at a check-out counter or teller window, for example, where the likelihood of foreign objects falling into the transportation path is high. However, by covering the tall part of the transportation path guide walls where the image scanner is located with a cover member to prevent foreign objects from entering, the operating rate of the information reading apparatus can be improved.

The invention also provides a transportation path opening/closing mechanism having a data reader disposed to a U-shaped transportation path for conveying a transported medium for reading information recorded to the transported medium; a transportation path opening/closing block for opening/closing a portion of the U-shaped transportation path in the area where the data reader is disposed to the U-shaped transportation path; transportation rollers disposed to the U-shaped transportation path at a position other than where the data reader is disposed for conveying the transported medium by means of a feed roller and pressure roller that rotate holding the transported medium; and a roller pressure block for reducing the pressure load on the pressure roller when the transportation path opening/closing block is open, and applying a specific elastic load to the pressure roller when the transportation path opening/closing block is in the closed position, in conjunction with opening/closing the transportation path opening/closing block.

When a paper jam occurs in the part of the transportation path that is taller than the transported medium, this transportation path opening/closing mechanism of the invention enables opening the transportation path opening/closing block to expose and access the transportation path to easily remove the paper jam. Furthermore, because the holding force of the transportation rollers is relieved by reducing the pressure load on the pressure roller in conjunction with opening the transportation path opening/closing block, the paper jam can be easily corrected without damaging the transported medium. Note that as used herein reducing the pressure load on the pressure roller refers to both weakening the elastic load on the pressure roller and completely removing this elastic load so that no pressure is exerted by the pressure roller on the drive or feed roller.

Yet further preferably, the transportation path opening/closing block is attached at one end thereof to the main frame by means of a pivot joint enabling the transportation path opening/closing block to rotate open and closed on the pivot joint.

This arrangement allows the transportation path opening/closing block to open and closed on the pivot joint similarly to a door swinging on a hinge, and thus enables the operator to open and access part of the transportation path easily without particular training.

Yet further preferably, the transportation path opening/closing block comprises a pressure engaging portion that engages the roller pressure block and applies pressure to the pressure roller by means of an intervening elastic member disposed to the roller pressure block when the transportation path opening/closing block is in the closed position, and disengages the roller pressure block when the transportation path opening/closing block is opened.

The pressure engaging portion of the transportation path opening/closing block in this aspect of the invention moves according to the opening/closing operation of the transportation path opening/closing block. When the transportation path opening/closing block is closed, this pressure engaging portion engages the roller pressure block, and thus exerts an elastic load on the pressure roller by means of the intervening elastic member disposed to the roller pressure block. When the transportation path opening/closing block opens, this pressure engaging portion separates from the roller pressure block, and the pressure urging force of this pressure engaging portion is removed. The elastic load applied to the pressure roller thus decreases.

Yet further preferably, the roller pressure block has a roller holding member that holds the pressure roller and can slide in the feed roller direction, and a pressure frame for urging and pressing the roller holding member in the feed roller direction by means of the intervening elastic member. The pressure engaging portion engages the pressure frame when the transportation path opening/closing block is closed, and pushes and urges the roller holding member in the feed roller direction by means of the intervening elastic member.

As the transportation path opening/closing block is closed, the pressure engaging portion first contacts the pressure frame. As the transportation path opening/closing block continues to the closed position, the pressure engaging portion moves while continuing to press against the pressure frame. As a result, the pressure frame exerts pressure on and pushes the roller holding member by means of the intervening elastic member. When the pressure roller held by the roller holding member contacts the feed roller and can move no further, the elastic member contracts according to the movement of the pressure frame by the pressure engaging member. Because pressure determined by the compression of the elastic member is exerted on the roller holding member, a constant pressure is always applied to the roller holding member as a result of the transportation path opening/closing block moving to the closed position. The pressure roller therefore contacts the feed roller with constant pressure, and a specific holding force is thus maintained between the transportation rollers.

When the transportation path opening/closing block opens, the pressure engaging member moves in the direction separating from the pressure frame. The pressure of the elastic member exerted on the roller holding member is thus gradually relieved, and the holding force of the transportation rollers weakens. When the pressure engaging member separates completely from the pressure frame, the urging force of the elastic member is completely lost, and the holding force of the transportation rollers is eliminated.

In the transportation path opening/closing mechanism thus comprised, a single pressure frame preferably pushes and urges a plurality of roller holding members.

By thus using a single common pressure frame to apply pressure on a plurality of roller holding members, the pressure frame exerts the same pressure on all roller holding members, and uniform pressure can thus be applied to a plurality of pressure rollers.

Yet further preferably, the pressure frame is held slidably to the main frame, and the roller holding member is held slidably to the pressure frame.

Alternatively, the roller holding member is held slidably to the main frame, and the pressure frame is held slidably to the roller holding member.

Further alternatively, the roller holding member and pressure frame are both held independently slidably to the main frame.

A further embodiment of the invention includes a transportation path opening/closing mechanism having a data reader disposed to a U-shaped transportation path for conveying a transported medium for reading information recorded to the transported medium; a transportation path opening/closing block for opening/closing a portion of the U-shaped transportation path in the area where the data reader is disposed to the U-shaped transportation path; first transportation rollers disposed to the U-shaped transportation path at a position other than where the data reader is disposed for conveying the transported medium by means of a feed roller and pressure roller that rotate holding the transported medium; and a roller opening/closing block comprising a pivot arm that pivots in conjunction with opening/closing of the transportation path opening/closing block, and a roller pressure arm of which one end is linked to the pivot arm by means of an elastic member and the other end holds the pressure roller. The roller opening/closing block adjusts the pressure load of the pressure roller on the feed roller by increasing or decreasing the elastic load of the roller pressure arm by means of the elastic member according to the pivoting motion of the pivot arm.

If a paper jam occurs in a part of the transportation path that is difficult to access, such as where the guide walls of the transportation path are high or in a curved portion of the transportation path, the transportation path opening/closing block of this transportation path opening/closing mechanism can be opened to easily access the area where the paper jam occurred.

Furthermore, by decreasing the pressure load of the pressure roller and thus reducing the holding force of the transportation rollers in conjunction with opening the transportation path opening/closing block, a paper jam can be removed easily without damaging the transported medium. More particularly, because the pivot arm and roller pressure arm are linked by an elastic member, and the pressure exerted by the pressure roller is changed by the pivoting action of the pivot arm, this aspect of the invention is suited as a transportation roller opening mechanism when the transportation path opening/closing block and transportation rollers are located with a curved portion of the U-shaped transportation path located therebetween.

More specifically, this aspect of a transportation path opening/closing mechanism according to the present invention can increase or decrease the pressure applied to a pressure roller that is separated from the transportation path opening/closing block and applies pressure in a direction substantially 90 degrees to the opening/closing direction of the transportation path opening/closing block as a result of pivoting the pivot arm linked to the opening/closing action of the transportation path opening/closing block.

Note that as used herein reducing the pressure load of the pressure roller is not limited to simply weakening the elastic load applied to the pressure roller, and also refers to completely removing the elastic load.

Preferably, the transportation path opening/closing block is attached at one end thereof to the main frame by means of a pivot joint enabling the transportation path opening/closing block to rotate open and closed on the pivot joint.

This arrangement allows the transportation path opening/closing block to open and closed on the pivot joint similarly to a door swinging on a hinge, and thus enables the operator to open and access part of the transportation path easily without particular training.

Further preferably, the transportation path opening/closing block comprises a pivoting engagement part that engages one end of the pivot arm when closed and disengages the pivot arm when opened.

The pivoting engagement part disposed to the transportation path opening/closing block thus moves in an arc following the circular movement of the transportation path opening/closing block. The load pressing on the pressure roller can thus be adjusted by pivoting the pivot arm according to the movement of this pivoting engagement part.

Further preferably, the elastic member is an elastic member of which one end engages the roller pressure arm and the other end engages the pivot arm; and the pivoting engagement part causes the pivot arm to rotate in the direction causing the elastic load of the elastic member to increase the pressure load of the pressure roller when the transportation path opening/closing block closes.

The elastic member could be a coil compression or extension spring, flat spring, or torsion spring, and the elastic force of the elastic member causes the roller pressure arm to pivot or slide so as to push the pressure roller to the feed roller.

Further preferably, the roller pressure arm can move circularly around a rotary shaft; and the elastic member is an extension spring of which one end is attached to the roller pressure arm and the other end is attached to the pivot arm.

Accordingly, closing the opening/closing block causes the pivot arm to move circularly, pulling the extension spring. The resulting tension from the extension spring thus causes the roller pressure arm to pivot in the direction pressing the pressure roller to the feed roller.

Yet further preferably, the first transportation rollers are disposed adjacent to the transportation path opening/closing block with a curved portion of the U-shaped transportation path between the first transportation rollers and the transportation path opening/closing block.

Yet further preferably, to reduce the holding force of second transportation rollers located on the opposite side of the transportation path opening/closing block as the first transportation rollers, the transportation path opening/closing mechanism also has a roller pressure block for applying an elastic load of specific strength to the pressure roller of the second transportation rollers when the transportation path opening/closing block is in the closed position, and reducing the pressure load of said pressure roller when the transportation path opening/closing block is opened, in conjunction with opening/closing the transportation path opening/closing block.

The pressure load (holding force) of the transportation rollers located adjacent to opposite sides of the transportation path opening/closing block on the U-shaped transportation path can thus be reduced by opening the transportation path opening/closing block. As a result, a paper jam can be easily removed without damaging the transported medium regardless of where the paper jam occurs.

Yet further preferably, the transportation path opening/closing block comprises a pressure engaging portion that engages the roller pressure block and applies pressure to the pressure roller of the second transportation rollers by means of an intervening elastic member disposed to the roller pressure block when the transportation path opening/closing block is in the closed position, and disengages the roller pressure block of the second transportation rollers when the transportation path opening/closing block is opened.

The pressure engaging portion of the transportation path opening/closing block thus moves according to the opening/closing operation of the transportation path opening/closing block. When the transportation path opening/closing block is closed, the pressure engaging portion and roller pressure block engage, and apply an elastic load on the pressure roller of the second transportation roller pair by way of the intervening elastic member disposed to the roller pressure block. When the transportation path opening/closing block opens, the pressure engaging portion separates from the roller pressure block, and the force of the pressure engaging portion acting on the elastic member is removed. The elastic load applied to the pressure roller of the second transportation roller pair thus decreases.

Further preferably, the roller pressure block has a roller holding member that holds the pressure roller of the second transportation rollers and can slide said pressure roller in the direction of the feed roller of the second transportation rollers, and a pressure frame for urging and pressing the roller holding member in the direction of the feed roller of the second transportation rollers by means of the intervening elastic member. The pressure engaging portion engages the pressure frame when the transportation path opening/closing block is closed, and pushes and urges the roller holding member in the direction of the feed roller of the second transportation rollers by means of the intervening elastic member.

As the transportation path opening/closing block is closed, the pressure engaging portion first contacts the pressure frame. As the transportation path opening/closing block continues to the closed position, the pressure engaging portion moves while continuing to press against the pressure frame. As a result, the pressure frame exerts pressure on and pushes the roller holding member by means of the intervening elastic member. When the pressure roller held by the roller holding member contacts the feed roller and can move no further, the elastic member contracts according to the movement of the pressure frame by the pressure engaging member. Because pressure determined by the compression of the elastic member is exerted on the roller holding member, a constant pressure is always applied to the roller holding member as a result of the transportation path opening/closing block moving to the closed position. The pressure roller therefore contacts the feed roller with constant pressure, and a specific holding force is thus maintained between the second transportation rollers.

When the transportation path opening/closing block opens, the pressure engaging member moves in the direction separating from the pressure frame. The pressure of the elastic member exerted on the roller holding member is thus gradually relieved, and the holding force of the second transportation rollers weakens. When the pressure engaging member separates completely from the pressure frame, the urging force of the elastic member is completely lost, and the holding force of the transportation rollers is eliminated.

Yet further preferably, the data reader includes one or both of an image scanner for imaging the transported medium, and a magnetic ink character reader for reading magnetic ink characters on the transported medium.

Yet further preferably, a data recording unit is disposed to a portion of the transportation path for recording information to the transported medium.

A further embodiment of the present invention includes a transportation path opening/closing mechanism having first and second transportation roller pairs disposed to a transportation path for conveying a transported medium and each having a rotationally driven feed roller and a pressure roller for pressing the transported medium to the feed roller, a transportation path opening/closing block for opening/closing a portion of the transportation path, and a roller opening/closing mechanism for advancing and retracting the pressure rollers of the first and second transportation roller pairs in the direction separating from the corresponding feed rollers in conjunction with opening/closing the transportation path opening/closing block. The roller opening/closing mechanism has a first pivot frame that moves circularly in conjunction with opening/closing the transportation path opening/closing block; a first roller holding member disposed slidably to one pivoting end of the first pivot frame, and holding the pressure roller to advance to and retract from the feed roller of the first transportation roller pair; a first roller urging spring mounted between the first pivot frame and first roller holding member for elastically urging the pressure roller held by the first roller holding member toward the feed roller of the first transportation roller pair; a second roller holding member for holding a pressure roller opposite the feed roller of the second transportation roller pair; a second pivot frame to which the second roller holding member is disposed on one end thereof; and a second roller urging spring mounted between the other pivoting end of the first pivot frame and the other pivoting end of the second pivot frame, and causing the second pivot frame to move circularly and elastically urging the pressure roller held by the second roller holding member in the direction of the feed roller of the second transportation roller pair in conjunction with the circular movement of the first pivot frame.

Opening the transportation path opening/closing block of this transportation path opening/closing mechanism exposes all or part of a jammed transported medium for external access and easy removal.

Furthermore, if part of the jammed transported medium is held by either or both of the first and second transportation roller pairs near the transportation path opening/closing block, the roller opening/closing mechanism opens in conjunction with opening the transportation path opening/closing block when the transportation path opening/closing block is opened to expose the paper jam. As a result, the pressure rollers of the first and second transportation roller pairs retract and separate from the corresponding feed rollers, and the holding force of the transportation roller pairs is reduced or eliminated.

As a result, when the transportation path opening/closing block is opened to expose the jammed transported medium, the transported medium is also released from the holding force of the first and second transportation rollers, and the jammed transported medium can be easily removed from the transportation path and the paper jam can be corrected with minimal force. The transported medium will therefore not be held with excess force when it is removed, and the transported medium can therefore be removed without being damaged.

Furthermore, when the transportation path opening/closing block is returned to the closed position after removing the paper jam, the roller opening/closing mechanism elastically urges the pressure rollers of the first and second transportation rollers to the corresponding feed rollers linked to the closing action of the transportation path opening/closing block, and thus restores the first and second transportation rollers to the positions enabling the transported medium to be held and conveyed between the feed rollers and pressure rollers.

Restoring the transportation path to the normal operating condition after removing a paper jam is thus simple, and less time is required to recover from a paper jam.

Retracting the pressure roller from the feed roller in the first and second transportation roller pairs in order to relieve the holding force on the transported medium when a paper jam occurs is achieved by the circular movement of the first and second pivot frames to which the pressure rollers are attached.

Therefore, compared with retracting the pressure rollers by means of a linearly moving mechanism, the positioning precision of the pressure rollers can be maintained with high precision using a simple mechanical construction, and the force of the first and second roller urging springs for elastically urging the pressure rollers to the feed rollers can be easily adjusted.

Furthermore, this aspect of the invention is suited to arrangements in which the first and second transportation rollers are located on different sides of a curved portion of the U-shaped transportation path because a second roller urging spring is mounted between the other pivoting end of the first pivot frame and the other pivoting end of the second pivot frame, the second pivot frame moves circularly linked to the circular movement of the first pivot frame, and the pressure roller held by the second roller holding member is elastically urged to the feed roller of the second transportation roller pair by the second roller urging spring.

More specifically, because the first pivot frame, which moves circularly in conjunction with the opening/closing operation of the transportation path opening/closing block, causes the second pivot frame to pivot, the pressure roller of the second transportation roller pair retracts from the feed roller, and the holding force of the transportation rollers can be reduced or eliminated even though the rollers are separated from the transportation path opening/closing block and are urged in a direction offset from the opening/closing direction of the transportation path opening/closing block.

Further preferably, the transportation path opening/closing block is assembled to the main frame with one end thereof functioning as a pivot axis that is parallel to the rotational axis of the first pivot frame to permit the transportation path opening/closing block to open and close relative to the frame, and with the transportation path opening/closing block comprising an engaging part that engages one pivoting end of the first pivot frame when closed and separates from the first pivot frame when opened.

This arrangement allows the transportation path opening/closing block to open and close on the pivot joint similarly to a door swinging on a hinge, and thus enables the operator to open and access part of the transportation path easily without particular training.

Further preferably, the rotational axis of the second pivot frame intersects the rotational axis of the first pivot frame.

This configuration enables the pressure rollers to apply an appropriate elastic force on the corresponding feed rollers even when the pressure roller of the first transportation roller pair and the pressure roller of the second transportation roller pair apply pressure in different directions and different positions.

Yet further preferably, the transportation path is substantially U-shaped with two curved portions, the first and second transportation roller pairs are disposed with the curved portion on the downstream side of the transportation path between the first and second transportation roller pairs, and the transportation path opening/closing block is disposed adjacent to the upstream side of the first transportation roller pair.

When transported medium is jammed near the second transportation roller pair, which is not exposed when the transportation path opening/closing block is open, the trailing end of the jammed transported medium is still exposed near the first transportation roller pair and can be accessed from the outside. As a result, the jammed transported medium can be easily removed.

Yet further preferably, at least one of a data reader for reading information on the transported medium, and a data recorder for recording information on the transported medium, is disposed in a portion of the transportation path.

Thus comprised, if the transported medium jams in the transportation path, the jammed transported medium can be removed easily without damage to the medium, less time is required to recover from a paper jam, and data processing can proceed efficiently.

A “data reader” as used herein refers to any device that can read information recorded on the transported medium, including image scanners and other image readers, MICR devices, and IC card readers.

Furthermore, a “data recorder” as used herein refers to any device that can record information to the transported medium, including printers, magnetic recording devices, and IC card writers.

The information processing apparatus and transportation path opening/closing mechanism of the present invention permits the transportation path to be exposed and accessed when the transported medium jams in the part of the transportation path where the image reader is disposed, and the holding pressure of the transportation rollers is reduced in conjunction with this opening action of the transportation path opening/closing mechanism. A transported medium that is jammed in the transportation path can therefore be easily removed without damaging the transported medium.

In addition, if the image reader becomes soiled and needs cleaning, the transportation path can be opened by means of the transportation path opening/closing mechanism disposed to the transportation path, and the image reader can therefore be easily cleaned.

Foreign objects are also prevented from entering the transportation path by closing the top opening to the transportation path by means of a cover member. Furthermore, this cover member can accurately fix the gap at the top portion of the transportation path walls even when a transportation path opening/closing mechanism for opening and closing a portion of the transportation path is provided. As a result, a specified dimensional tolerance can be maintained even when the walls of the transportation path are made of plastic, for example, thus contributing to a reduced size, weight, and cost.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1A is a schematic plan view of the transportation path and various parts disposed neighboring the transportation path in an image reading apparatus according to a first embodiment of the present invention;

FIG. 1B is a section view through F-F in FIG. 1A;

FIG. 2 is an oblique view seen from arrow J in FIG. 1A showing the transportation path opening/closing mechanism when closed;

FIG. 3 is an oblique view seen from arrow J in FIG. 1A showing the transportation path opening/closing mechanism when open;

FIG. 4 is an exploded oblique view showing the parts of the transportation path opening/closing mechanism;

FIG. 5 is an oblique external view of an image reading apparatus having a transportation path opening/closing mechanism according to a second embodiment of the invention;

FIG. 6A is a schematic plan view of the transportation path and various parts disposed neighboring the transportation path in the image reading apparatus shown in FIG. 5;

FIG. 6B is a section view through I-I in FIG. 6A;

FIG. 7 is an exploded oblique view seen from the direction of arrow N in FIG. 5 with the transportation path opening/closing mechanism open;

FIG. 8 is an exploded oblique view seen from the direction of arrow O in FIG. 5 with the transportation path opening/closing mechanism open;

FIG. 9 is an oblique view of the roller pressure block when assembled to the main frame;

FIG. 10 is an exploded oblique view of the roller pressure block;

FIG. 11 is an oblique view showing the assembly of the roller holding members and pressure frame from the back of the pressure frame;

FIG. 12 is a section view showing the relationship between the roller pressure block and the pressure engaging portion when the transportation path opening/closing block is closed;

FIG. 13 is a section view showing the relationship between the roller pressure block and the pressure engaging portion when the transportation path opening/closing block is open;

FIG. 14 is an oblique view of the roller opening/closing block showing the second transportation roller release mechanism;

FIG. 15 is a partial section view of the roller opening/closing block when the transportation path opening/closing block is closed;

FIG. 16 is a partial section view of the roller opening/closing block just after the transportation path opening/closing block is opened;

FIG. 17 is an oblique external view of the image reading apparatus having a transportation path opening/closing mechanism according to a third embodiment of the invention;

FIG. 18A is a schematic plan view of the transportation path and various parts disposed neighboring the transportation path in the image reading apparatus shown in FIG. 17;

FIG. 18B is a section view through R-R in FIG. 18A;

FIG. 19 is an oblique view from the direction of arrow T in FIG. 17 when the transportation path opening/closing block is closed;

FIG. 20 is an oblique view from the direction of arrow T in FIG. 17 when the transportation path opening/closing block is open;

FIG. 21 is an oblique view from the direction of arrow U in FIG. 1 when the transportation path opening/closing block is open;

FIG. 22 is an exploded oblique view of the transportation path opening/closing block;

FIG. 23 is an exploded oblique view of the cover member installation assembly;

FIG. 24 is an oblique external view of the image reading apparatus having a transportation path opening/closing mechanism according to a fourth embodiment of the invention;

FIG. 25A is a schematic plan view of the transportation path and various parts disposed neighboring the transportation path in the image reading apparatus shown in FIG. 17;

FIG. 25B is a section view through V-V in FIG. 25A;

FIG. 26 is an oblique view from the back of the image reading apparatus seen from arrow W in FIG. 24 when the opening/closing mechanism is closed;

FIG. 27 is an oblique view from the back of the image reading apparatus seen from arrow W in FIG. 24 when the opening/closing mechanism is open;

FIG. 28 is a partial exploded oblique view of the roller opening/closing mechanism shown in FIG. 27;

FIG. 29 is an oblique view of the major parts of the complete roller opening/closing mechanism shown in FIG. 27;

FIG. 30 describes when the first pivot frame shown in FIG. 28 is moved circularly in the direction releasing the pressure of the pressure rollers;

FIG. 31 describes when the first pivot frame shown in FIG. 28 is returned to the closed position; and

FIG. 32 is an oblique view of a conventional image reading apparatus having a U-shaped transportation path for conveying a transported medium.

### DESCRIPTION OF THE PREFERRED EMBODIMENTS

An information processing apparatus and transportation path opening/closing mechanism according to preferred embodiments of the present invention are described below with reference to the accompanying figures.

### Embodiment 1

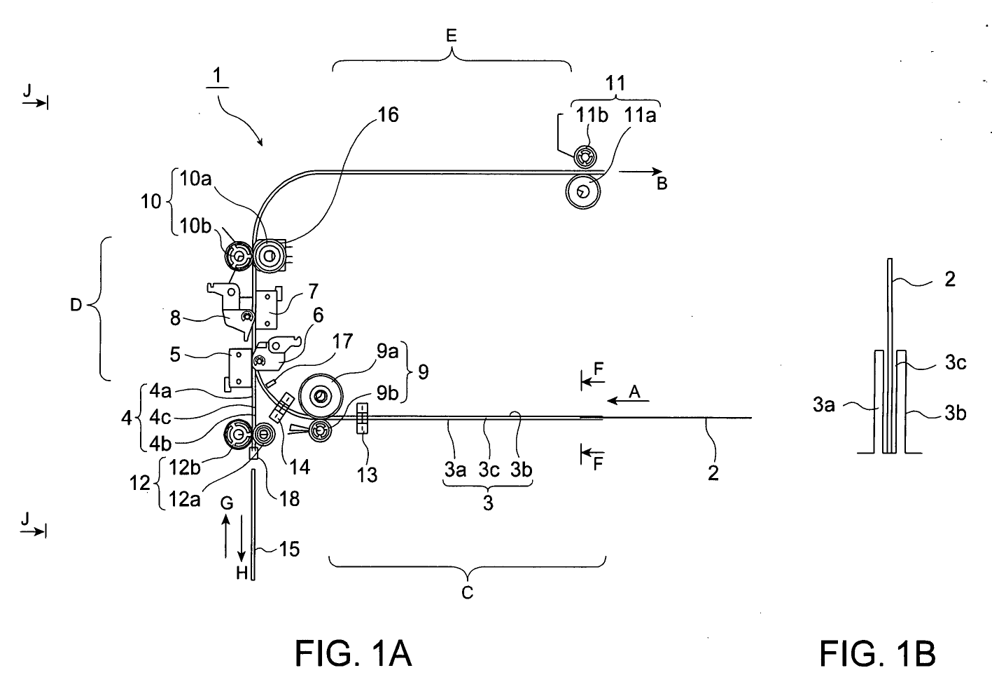

An image reading apparatus (information processing apparatus) 1 as is shown in FIG. 1 has a U-shaped transportation path 3 for conveying a first transported medium 2. A first scanner (image reading unit) 5 and a second scanner 7 for imaging opposite sides of the first transported medium 2 are disposed to the straight portion (middle transportation path D) connecting the two curved parts of the transportation path 3.

A straight transportation path 4 is also connected in a straight line with the middle transportation path D. A second transported medium 15 is conveyed through the straight transportation path 4 and middle transportation path D, and can thus be scanned on one or both sides by first and second scanners 5 and 7.

The first transported medium 2 conveyed through the U-shaped transportation path 3 is a check or other pliable medium. The second transported medium 15 conveyed through the straight transportation path including the straight transportation path 4 and middle transportation path D is a driver license, credit card, or other relatively stiff medium that is not easily bent. The first transported medium 2 can, of course, also be conveyed through the straight transportation path.

The transportation path 3 has an outside guide wall 3a and an inside guide wall 3b for guiding the transported medium on both sides. Transportation roller pairs 9 to 12 for conveying the first and/or second transported medium are disposed to the transportation path 3 and straight transportation path 4 at specific intervals determined by the length of the transported medium.

Each transportation roller pair 9 to 12 includes a drive roller 9a to 12a to which drive power is transferred from a drive motor not shown, and a pressure roller 9b to 12b for pressing the transported medium to the opposing drive roller 9a to 12a.

In addition to the first scanner 5 and second scanner 7, a MICR (magnetic ink character reader) 16 for reading magnetic ink characters printed on the first transported medium 2 is disposed to the middle transportation path D, which is shared by the U-shaped transportation path 3 and the straight transportation path 4.

The U-shaped transportation path 3 is described in further detail below.

As shown in FIG. 1B, the transportation path 3 has an outside guide wall 3a and an inside guide wall 3b, and the first transported medium 2 is conveyed through the transportation space 3c between these two walls 3a and 3b.

As shown in FIG. 1A, the first transported medium 2 is inserted in the direction of arrow A to the straight transportation path C on the entrance side of the transportation path 3. The height of the outside guide wall 3a and inside guide wall 3b in this straight transportation path C is less than the height of the first transported medium 2 (see FIG. 1B). As a result, the first transported medium 2 can be easily removed if a paper jam occurs.

When a first detector 13 located along the straight transportation path C detects the leading end part of an inserted first transported medium 2, the transportation roller pairs 9 to 12 begin to turn, and the first transported medium 2 is thus nipped by the first transportation roller pair 9 and advanced. The first transportation roller pair 9 thus conveys the first transported medium 2 from the straight transportation path C through the curved transportation path and into the middle transportation path D.

When a second detector 14 located in the curved transportation path detects the leading end of the first transported medium 2, the first scanner 5, second scanner 7, and MICR 16 are enabled. Both sides of the first transported medium 2 are thus imaged by the first scanner 5 and second scanner 7, and magnetic ink character information is read by MICR 16 from the first transported medium 2, as the processed medium is conveyed through the middle transportation path D.

The first transported medium 2 is then nipped by the second transportation roller pair 10 located on the middle transportation path D, and the second transportation roller pair 10 conveys the first transported medium 2 from the middle transportation path D through the curved transportation path and into the straight transportation path E on the discharge side.

The transportation direction of the first transported medium 2 is thus changed 180 degrees as a result of the first transported medium 2 passing through the two curved parts of the transportation path 3, and the first transported medium 2 is nipped by the discharge rollers 11 located on straight transportation path E and discharged in the direction of arrow B.

The image scanning process is described in detail next.

The first scanner 5 is located on the outside guide wall 3a side of the transportation path 3, and a first pressure mechanism 6 is disposed on the inside guide wall 3b side opposite the first scanner 5. A pressure roller 6a in the first pressure mechanism 6 presses the first transported medium 2 to the scanning surface of the first scanner 5, and the first scanner 5 images one side of the first transported medium 2 as the medium 2 is conveyed over the first scanner 5.

The second scanner 7 is located downstream from the first pressure mechanism 6, and a second pressure mechanism 8 is located opposite the second scanner 7 on the outside guide wall 3a side of the transportation path 3. A pressure roller 8a in the second pressure mechanism 8 similarly presses the first transported medium 2 to the scanning surface of the second scanner 7, and when the first transported medium 2 passes over the second scanner 7, the second scanner 7 images the other side of the first transported medium 2.

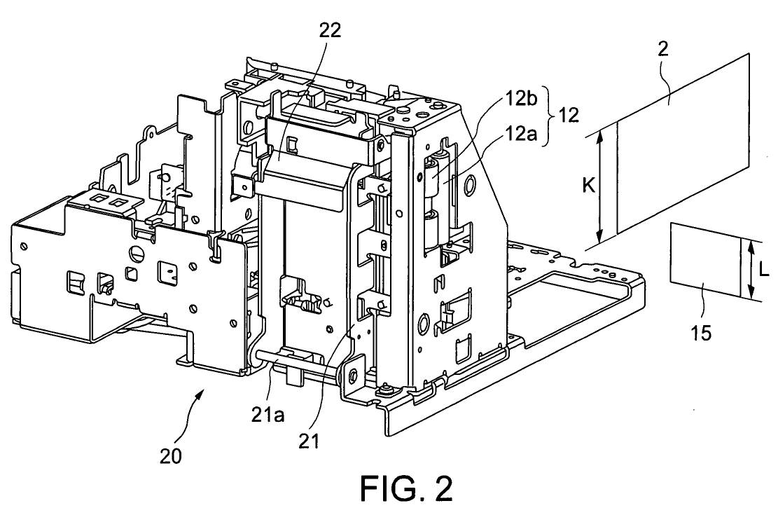

The first scanner 5 and second scanner 7 can image the entire area of the tallest first transported medium 2 that is processed, and the information processing apparatus is therefore taller than the height of these scanners. The first pressure mechanism 6 and second pressure mechanism 8 are also taller than the tallest transported medium that is handled. The outside guide wall 3a to which the first scanner 5 and second pressure mechanism 8 are disposed, and the inside guide wall 3b to which the second scanner 7 and first pressure mechanism 6 are disposed, are therefore both taller than the first transported medium 2. See FIG. 2.

A first transported medium 2 passing through the middle transportation path D to which the first scanner 5 and second scanner 7 are disposed is thus covered on both sides by the outside guide wall 3a and inside guide wall 3b.

If the first transported medium 2 jams in this area, recovering the jammed medium from the paper jam will be difficult because the inside of the middle transportation path D cannot be accessed.

To provide the access necessary to solve this problem, this embodiment of the invention has a transportation path opening/closing mechanism for exposing the jammed part of the transportation path. This transportation path opening/closing mechanism is described in detail further below.

The MICR 16 for reading magnetic ink characters printed on the first transported medium 2 is disposed below the second transportation roller pair 10, and the magnetic ink characters are read by the MICR 16 when the first transported medium 2 passes over the MICR 16. A magnet 17 for magnetizing the magnetic ink characters on the first transported medium 2 is also disposed adjacent to the first pressure mechanism 6.

As a first transported medium 2 inserted from the direction of arrow A into the U-shaped transportation path 3 is conveyed by the first and second transportation roller pairs 9 and 10, the first scanner 5 and second scanner 7 image opposite sides of the first transported medium 2, magnetic ink character information is read by the MICR 16, and the first transported medium 2 is then discharged by the discharge rollers 11 in the direction of arrow B.

The straight transportation path for imaging the second transported medium 15 is described next.

As noted above, this transportation path includes the middle transportation path D and the straight transportation path 4 formed in line with and connected to the middle transportation path D. The straight transportation path 4 conveys a second transported medium 15 through a transportation space 4c rendered between an outside guide wall 4a and an inside guide wall 4b. The middle transportation path D is used for imaging both first and second transported media 2 and 15. The height of the second transported medium 15 is less than the height of the first transported medium 2, and only the top half of the middle transportation path D is therefore used to convey second transported media 15. As with the first transported medium 2, however, second transported media 15 passing through the middle transportation path D are covered by the outside guide wall 3a and inside guide wall 3b.

Second transported media 15 are inserted from the direction of arrow G to the straight transportation path 4. When a third detector 18 detects the leading end of the inserted second transported medium 15, the straight transportation path rollers 12 and other transportation path rollers start turning. As with the other transportation path roller pairs, the straight transportation path roller pair 12 includes a drive roller 12a to which drive power is transferred from a drive motor, and a pressure roller 12b.

The second transported medium 15 is thus conveyed by the straight transportation path rollers 12 to the middle transportation path D. The second transported medium 15 is then nipped and conveyed by the second transportation roller pair 10 until the trailing end of the second transported medium 15 is conveyed to a position beyond the second scanner 7. The second transported medium 15 then stops.

The second transported medium 15 is then conveyed in the reverse direction and both sides are imaged as the second transported medium 15 passes the second scanner 7 and first scanner 5. The second transported medium 15 is then discharged in the direction of arrow H from the same position where the medium was inserted.

A preferred embodiment of a transportation path opening/closing mechanism 20 according to the present invention is described next below with reference to FIG. 2 to FIG. 4.

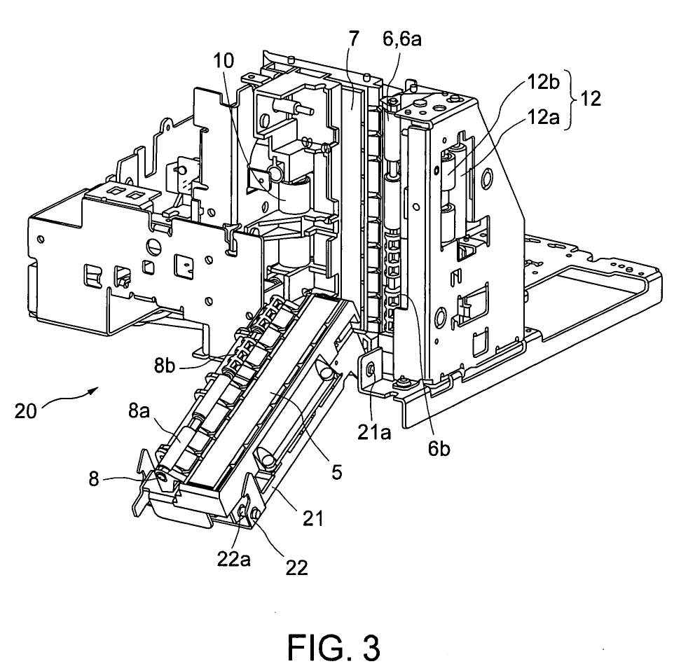

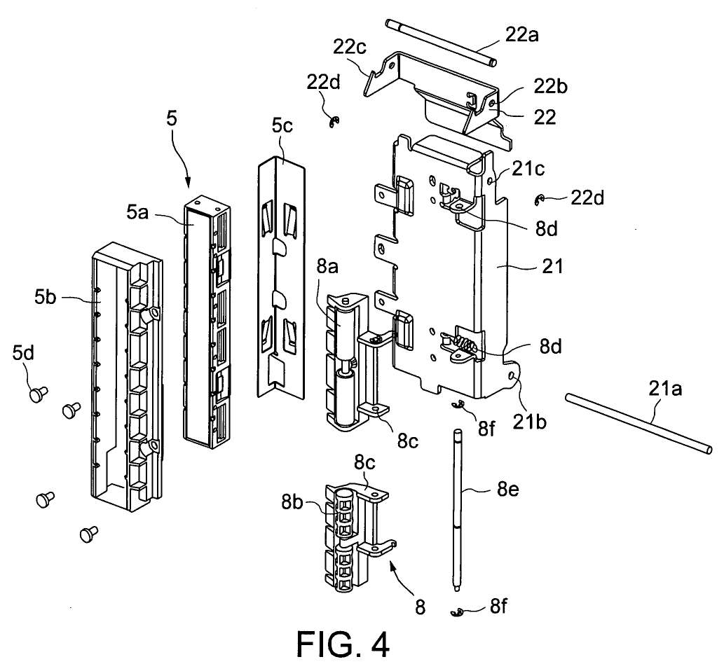

FIG. 2 and FIG. 3 are internal oblique views of the image reading apparatus 1 as seen from arrow J in FIG. 1A. FIG. 2 shows the transportation path opening/closing mechanism 20 closed, and FIG. 3 shows the transportation path opening/closing mechanism 20 open. FIG. 4 is an exploded oblique view of the transportation path opening/closing mechanism 20.

As shown in FIG. 2, the guide walls of the transportation path where the first scanner 5 and second scanner 7 are disposed are taller than the height at which the top of the first and second transported media 2, 15 are located during transportation. It is therefore difficult to access the inside of the transportation path to remove media jammed inside the transportation path.

The transportation path opening/closing mechanism 20 according to this embodiment of the invention therefore has an opening/closing wall 21 that opens and closes on the outside guide wall 3a side of the U-shaped transportation path 3 as shown in FIG. 3 to expose the guide wall 3a. When this opening/closing wall 21 on the outside guide wall 3a side is open, the transportation path through the guide wall 3a is and accessible, and a jammed first or second transported medium 2, 15 between the guide walls can be easily removed.

This transportation path opening/closing mechanism 20 includes parts as shown in FIG. 4. The first scanner 5 and second pressure mechanism 8 are assembled within the opening/closing mechanism 20 to form an integral part of the opening/closing wall 21, which is a part of the outside guide wall 3a. A pivot shaft holder (hole) 21b is disposed at the bottom part of the opening/closing wall 21, and the opening/closing wall 21 is pivotably assembled to the housing of the image processing apparatus 1 by means of a pivot shaft 21a. The pivot joint thus formed enables the opening/closing wall 21 to swing on the pivot shaft 21a and thus open and close similarly to a door. When the opening/closing wall 21 is closed, the first scanner 5 is disposed opposite the first pressure mechanism 6, and the second pressure mechanism 8 is disposed opposite the second scanner 7.

A lever bearing (hole) 21c is also rendered in the top part of the opening/closing wall 21, a corresponding bearing (hole) 22b is also formed in the lever 22, and this lever 22 is assembled to the opening/closing wall 21 by means of a pivot shaft 22a passing through lever bearing 21 c and bearing 22b.

The lever 22 can thus rotate on the pivot shaft 22a so that when the opening/closing wall 21 is closed, the lever 22 rotates up and hooks 22c on the distal end of the lever 22 catch pins (not shown) disposed on the image reading apparatus side, thereby locking the opening/closing wall 21 closed. To open the opening/closing wall 21, the lever 22 is rotated down to disengage the hooks 22c from the pins and unlock the opening/closing wall 21. The opening/closing wall 21 can then be swung down and open. Note that the pivot shaft 22a is secured to the lever bearing 21c by a snap ring 22d or other means.

The first scanner element 5a is attached to the opening/closing wall 21 through intervening sheet member 5c, and the scanner cover 5b is then placed over the first scanner element 5a and affixed to the opening/closing wall 21 by a plurality of pins 5d. The first scanner 5 is thus assembled to the opening/closing wall 21.

Movable brackets 8c are mounted by a shaft 8e to the two mounting brackets 8d disposed above and below adjacent to the first scanner 5. Pressure roller 8a is rotatably assembled to the movable bracket 8c mounted to the top mounting bracket 8d. Pressure roller 8b is similarly rotatably assembled to the movable bracket 8c mounted to the bottom mounting bracket 8d.

The second pressure mechanism 8 is thus assembled to the opening/closing wall 21. Both movable brackets 8c are urged by springs not shown to press the first or second transported medium 2, 15 to the scanning surface of the second scanner 7. When the opening/closing wall 21 is closed, pressure rollers 8a, 8b thus press the first or second transported medium 2, 15 to the scanning surface of the second scanner 7. Note that the pivot shaft 8e is secured to the pair of mounting brackets 8d by a snap ring 8f or other means.

Because the second transported medium 15 is conveyed using only the top half of the transportation path as described above, the second transported medium 15 contacts only the upper pressure roller 8a in the second pressure mechanism 8. Depending on the height of the first transported medium 2, however, the first transported medium 2 may contact only the lower pressure roller 8b or both the upper and lower pressure rollers 8a and 8b.

The first pressure mechanism 6 and second scanner 7 disposed on the inside guide wall 3b side have the same basic construction as the first scanner 5 and second pressure mechanism 8 described above.

As a result, when the opening/closing wall 21 is closed, the first pressure mechanism 6 works to press the first or second transported medium 2, 15 to the scanning surface of the first scanner 5, and the second pressure mechanism 8 works to press the first or second transported medium 2, 15 to the scanning surface of the second scanner 7. As a result, both sides of the first and second transported media 2, 15 can be imaged.

Note that transportation roller pairs for holding and conveying first and second transported media 2, 15 are not located in the area where the transportation path opening/closing mechanism 20 of the invention is rendered. The distance between the first transportation roller pair 9, second transportation roller pair 10, and straight transportation path rollers 12 is determined so that the first or second transported medium 2, 15 is always held and conveyed by at least one of the transportation roller pairs.

Because the first or second transported medium 2, 15 is thus always held by one of the transportation roller pairs, there is no danger of the first or second transported medium 2, 15 being damaged as a result of being dropped even if the opening/closing wall 21 is opened.

More specifically, because of the magnet 17 located beside the first pressure mechanism 6, a second transported medium 15 containing magnetic information, such as a credit card, is susceptible to damage to the magnetically encoded information if the second transported medium 15 drops down into the transportation path. However, because the first or second transported medium 2, 15 is always held by one of the transportation roller pairs, there is no danger of the second transported medium 15 falling down beside the magnet 17 and damage to the magnetically encoded information is prevented.

The image processing or reading apparatus having a transportation path opening/closing mechanism according to the foregoing first embodiment of the invention is described as having two scanners for imaging both sides of the transported medium. It will be obvious, however, that this transportation path opening/closing mechanism can also be adapted for implementations having only one scanner for imaging one side of the transported medium, and implementations having three or more scanners.

This first embodiment of the invention is also described using by way of example an implementation having an MICR, but the invention can obviously be applied to implementations not having an MICR, and to implementations having a printer (information recording unit) for printing to the first transported medium 2.

This first embodiment is also described having a straight transportation path in addition to the U-shaped transportation path 3, but could obviously have only a U-shaped transportation path.

Yet further, the scanners are disposed to the straight part of the transportation path located between the two curved parts of the U-shaped transportation path 3 in the foregoing embodiment, but the invention can obviously also be used when the scanners are located in a different part of the transportation path.

### Second Embodiment

An image processing or reading apparatus 110 having a transportation path opening/closing mechanism according to a second embodiment of the present invention is described in detail next.

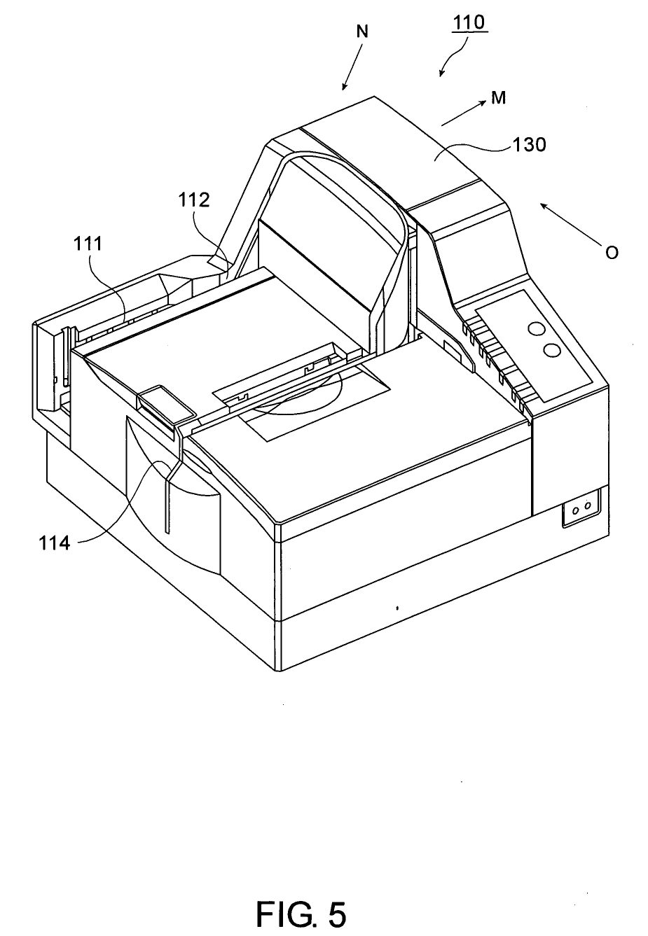

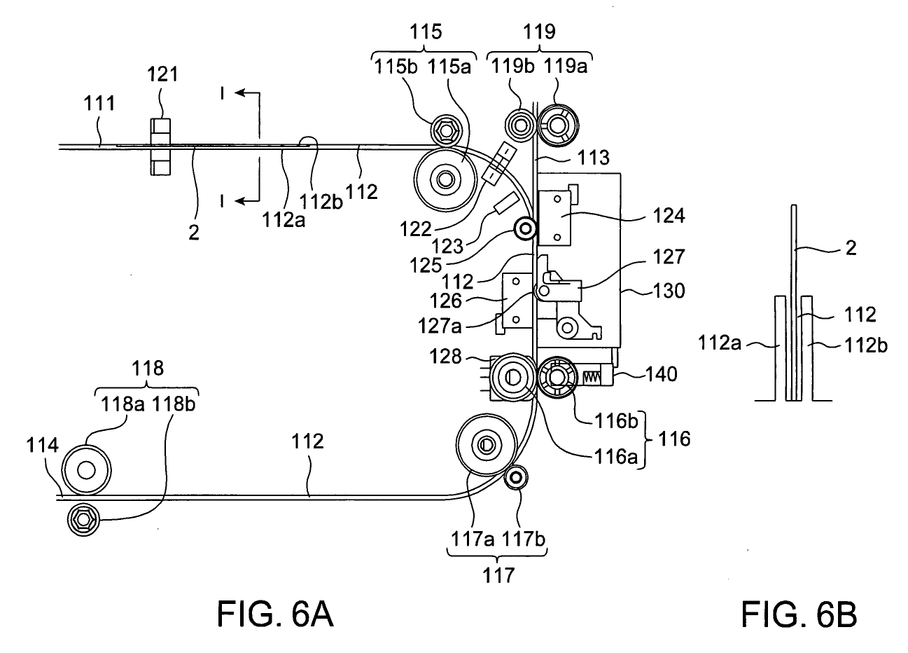

FIG. 5 is an oblique external view of the image reading apparatus 110 according to this second embodiment of the invention. FIG. 6A is a schematic plan view of the transportation path and various parts disposed along the transportation path in the image reading apparatus 110 shown in FIG. 5. FIG. 6B is a section view through I-I in FIG. 6A.

This image reading apparatus 110 has a loading unit 111 to which checks, slips, or other first transported medium 2 are inserted, a U-shaped transportation path 112 for conveying the inserted first transported medium 2, and an exit 114 for discharging the first transported medium 2 after reading or other processing is completed. A transportation path opening/closing block 130 for opening part of the transportation path 112 is also disposed to the transportation path 112.

As shown in FIG. 6A, an image reading apparatus 110 according to this second embodiment of the invention has a U-shaped transportation path 112 for conveying a first transported medium 2 that bends easily, such as a check, and a straight transportation path 113 shown on the right side in FIG. 6A. The straight transportation path 113 conveys a second transported medium 15 that does not bend easily, such as ID cards and driver licenses. This straight transportation path 113 shares part of the U-shaped transportation path 112.

Disposed along the transportation path 112 in this image reading apparatus 110 are a detector 121 near the loading unit 111, transportation roller pair 115, magnet 123, two contact image scanners (CIS) or other type of image reader (information reading units) 124 and 126, pressure rollers 125 and pressure mechanism 127 for pressing the transported medium to the image readers 124, 126, transportation roller pairs 116, MICR (magnetic ink character reader) head 128 disposed below the transportation roller pairs 116, and transportation roller pairs 117 and 118 for guiding the first transported medium 2 to the exit 114. The image readers 124, 126 respectively image the first side (the front, for example) and the second side (the back, for example) of the first transported medium 2. Note that only four transportation roller pairs 115 to 118 are shown in FIG. 6A to simplify the description, but feed rollers could also obviously be disposed near the loading unit 111 to feed the inserted first transported medium 2 into the transportation path 112.

A printer (information recording unit) could also be disposed to the U-shaped transportation path 112 between the MICR head 128 and exit 114 for printing to the front or back of the first transported medium 2.

The transportation path 112 is described next.

As shown in FIG. 6B, the transportation path 112 has an inside guide wall 112a and an outside guide wall 1 12b for guiding the first transported medium 2 on both sides, and conveys the first transported medium 2 through the space between these two guide walls.

The height of the inside guide wall 112a and outside guide wall 112b in the transportation path 112 near the loading unit 111 and exit 114 is shorter than the first transported medium 2, and the top part of the first transported medium 2 is thus exposed above the U-shaped transportation path 112. If a paper jam occurs in this area, it is therefore relatively easy to remove the first transported medium 2 from the U-shaped transportation path 112.

When the first transported medium 2 inserted from the loading unit 111 is detected by the detector 121, the first transported medium 2 is fed into the transportation path 112 by feed rollers not shown, and is then transported by the transportation roller pairs 115 to 118.

These transportation roller pairs 115 to 118 each include a drive roller (feed roller) 115a to 118a and a pressure roller 115b to 118b. The relationship between the drive roller and pressure roller in each transportation roller pair is described below using transportation roller pair 115 by way of example.

The drive roller 115a is rotationally driven by a transportation motor not shown. The pressure roller 115b is urged to press against the drive roller 115a. When the first transported medium 2 is held between the drive roller 115a and pressure roller 115b, the first transported medium 2 is transported through the transportation path 112 in the direction of drive roller 115a rotation. Transportation roller pairs 115 to 118 are all similarly configured.

The first transported medium 2 is read by the first and second image readers 124, 126 as it is conveyed through the transportation path 112. A magnet 123 for magnetizing the magnetic ink characters is disposed downstream from the transportation roller pair 115 so that the magnetic ink characters printed along the bottom of a check, for example, can be read. The magnetized magnetic ink characters are then read by the MICR head 128 located downstream of the first and second image readers 124,126.

When a first transported medium 2 travelling through the transportation path 112 is detected by the detector 122 disposed upstream of the first image reader 124, the output detection signal triggers the reading processes timed to the first transported medium 2 passing the first image reader 124, second image reader 126, and MICR head 128.

When processing ends, the first transported medium 2 is discharged from the exit 114.

The image reading processes are described next.

The first image reader 124 is located on the outside guide wall 112b side, and pressure rollers 125 are located opposite the first image reader 124 on the inside guide wall 112a side. The first transported medium 2 is pressed by the pressure rollers 125 to the scanning surface of the first image reader 124, and when the first transported medium 2 passes the first image reader 124, the first image reader 124 images the one side of the first transported medium 2.

The second image reader 126 is located on the inside guide wall 112a side downstream from the first image reader 124. The pressure mechanism 127 is located at a position opposite the second image reader 126 on the other side of the U-shaped transportation path 112 (on the outside guide wall 112b side). Pressure rollers 127a are located on the distal end of the pressure mechanism 127, and the first transported medium 2 travelling through the transportation path 112 is pressed to the scanning surface of the second image reader 126 by the pressure rollers 127a. As a result, the other side of the first transported medium 2 is imaged by the second image reader 126 as the first transported medium 2 passes the second image reader 126.

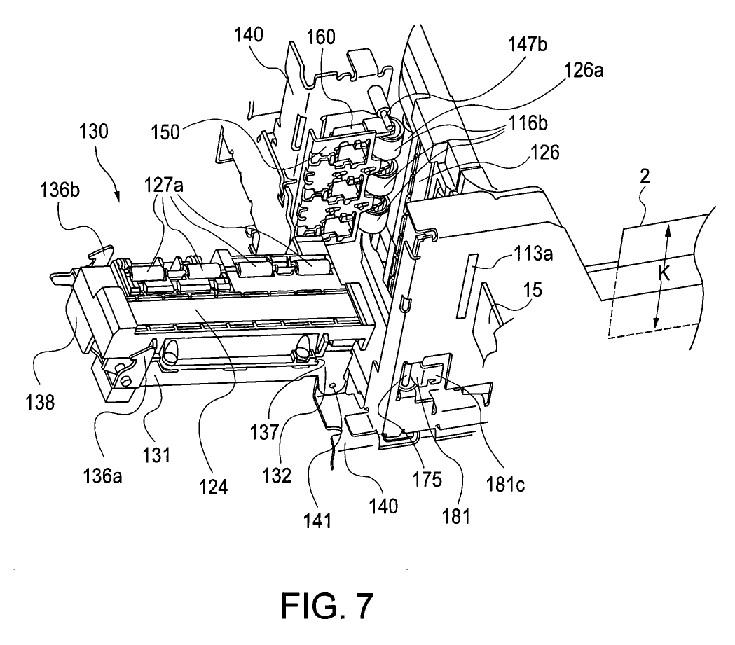

Because the first image reader 124 and second image reader 126 scan a full image of the first transported medium 2, the height of the scanning surface of the first image reader 124, the scanning surface of the second image reader 126, the inside guide wall 112a, and the outside guide wall 112b forming the U-shaped transportation path 112 in this area is greater than the height K of the first transported medium 2. See FIG. 5 and FIG. 7.

Both sides of the first transported medium 2 are therefore covered by the inside guide wall 112a and outside guide wall 112b in the area where the first image reader 124 and second image reader 126 are located. It is therefore difficult to recover from a paper jam if the first transported medium 2 jams in the U-shaped transportation path 112 in this area because the inside of the U-shaped transportation path 112 cannot be accessed.

To provide the access necessary to solve this problem, an image reading apparatus 110 according to this embodiment of the invention has a transportation path opening/closing mechanism for opening part of the U-shaped transportation path 112 in the area where the first image reader 124 and second image reader 126 are located, and a transportation roller release mechanism for releasing the holding pressure of the transportation roller pairs adjacent to the transportation path opening/closing mechanism in conjunction with the opening/closing operation of the transportation path opening/closing mechanism so that a jammed first transported medium 2 can be easily removed. This transportation path opening/closing mechanism is described in detail further below.

The straight transportation path 113 is described next.

A straight transportation path 113 for feeding second transported medium 15 is disposed where the first and second image readers 124, 126 are located so that the first and second image readers 124, 126 can be used to image and read a driver license, ID card, or other second transported medium 15 that is not pliable, i.e., cannot be conveyed through the U-shaped transportation path.

A second transported medium 15 is inserted from a card insertion opening 113a (see FIG. 7) to the straight transportation path 113. When a detector not shown detects insertion of a second transported medium 15, transportation roller pairs 119, 116 start to turn. Transportation roller pair 119 includes a drive roller 11 9a and pressure roller 119b similarly to the other transportation roller pairs.

The second transported medium 15 is thus conveyed by transportation roller pairs 119, 116 until the trailing end of the second transported medium 15 reaches a position passed the second image reader 126, and then stops. The second transported medium 15 is then conveyed in the reverse direction and imaged on both sides as it passes the second image reader 126 and first image reader 124, and is then discharged from the card insertion opening 113a.

This embodiment of the invention improves efficiency by sharing the first and second image readers 124, 126 and the straight part of the U-shaped transportation path 112 for imaging and reading the first and second transported media 2, 15. Note that because the cards that are second transported media 15 are shorter than the checks, slips, and other first transported media 2, second transported media 15 are conveyed and imaged using only the upper part of the transportation path 112. It will also be obvious that the lower part of the transportation path 112 could be used for processing second transported media 15.

The transportation path opening/closing mechanism and transportation roller opening mechanism for facilitating removing paper jams in conjunction with operation of the transportation path opening/closing mechanism are described next with reference to FIG. 7 to FIG. 13 according to a second embodiment of the invention.

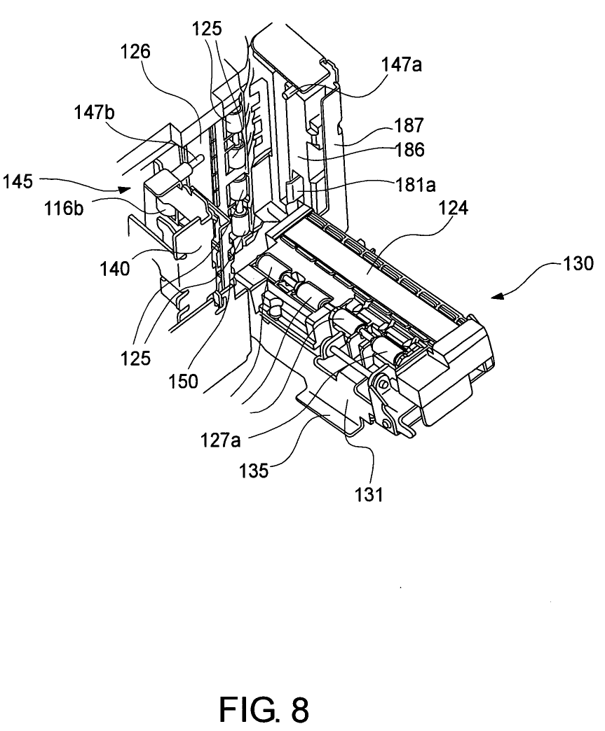

As shown in FIG. 7 and FIG. 8, a transportation path opening/closing mechanism according to this embodiment of the invention has a transportation path opening/closing block 130 on the outside guide wall 112b side of the U-shaped transportation path 112. If a paper jam occurs, the transportation path opening/closing block 130 can be opened to the outside of the image reading apparatus, that is, in the direction of arrow M, to open and access the inside of part of the transportation path 112.

FIG. 7 shows the transportation path opening/closing block 130 swung approximately 90 degrees to the outside, thus opening and exposing part of the U-shaped transportation path 112. An opening/closing wall 131, the first image reader 124, and pressure mechanism 127 that are part of the outside guide wall 112b are disposed to the transportation path opening/closing block 130. A pivot shaft holder 132 is rendered at the bottom of the opening/closing wall 131. This pivot shaft holder 132 is rotatably assembled to the pivot shaft 141 that is fixed to the main frame 140 of the image reading apparatus 110. This pivot shaft 141 and pivot shaft holder 132 thus form a pivot joint.

This pivot joint allows the transportation path opening/closing block 130 to swing open and closed on the pivot shaft 141. When the transportation path opening/closing block 130 is closed, the first image reader 124 is positioned opposite the pressure rollers 125, and the pressure rollers 127a of the pressure mechanism 127 are positioned opposite the second image reader 126.

Hooks 136a, 136b disposed to the distal end of the opening/closing wall 131 are urged upward (when the opening/closing wall 131 is vertical) by a torsion spring (not shown), for example. When the transportation path opening/closing block 130 is closed, these hooks 136a, 136b thus engage corresponding catch pins 147a, 147b (see FIG. 7, FIG. 8) and thus lock the opening/closing wall 131 closed. To open the opening/closing wall 131, a lever 138 is lifted up, thus causing the hooks 136a, 136b to rotate down and disengage the catch pins 147a, 147b. The transportation path opening/closing block 130 can then pivot to the outside on the pivot shaft 141, thus opening the transportation path 112.

The transportation path opening/closing block 130 is rendered at the location of the first image reader 124 and second image reader 126 on the U-shaped transportation path 112. As a result, by opening the transportation path opening/closing block 130 when a paper jam occurs, the paper jam can be removed without exerting undue force on the scanning surface, thus preventing soiling or marring the scanning surface.

An interlock can be provided to prevent current from flowing to the various parts of the image reading apparatus 110 when the transportation path opening/closing block 130 is opened.

This image reading apparatus 110 also has a transportation roller release mechanism for releasing the holding force of the transportation roller pairs in conjunction with opening the transportation path opening/closing block 130.

Note that “releasing the holding force” as used herein refers both to removing the holding force completely, and reducing the holding force. The holding force of the transportation roller pairs 115 and 116 is released in this embodiment of the invention by reducing the pressure of the pressure roller 115b or 116b against the opposing drive roller 115a or 116a.

The release mechanism for transportation roller pairs 116 (referred to below as the first transportation roller release mechanism) is described first. This first transportation roller release mechanism linearly slides the pressure rollers 116b to increase or decrease the elastic load on the pressure rollers 116b and thereby adjust the holding force of the transportation roller pairs 116.

As shown in FIG. 8, the opening/closing wall 131 of the transportation path opening/closing block 130 has a pressure engaging portion 135 that engages a roller pressure block 145. The roller pressure block 145 releases the holding force of the transportation roller pairs 116.

When the opening/closing wall 131 of the transportation path opening/closing block 130 is closed, the pressure engaging portion 135 engages the pressure frame 150 of the roller pressure block 145, thus pushing and moving the pressure frame 150 in the direction of the transportation path 112 to a specific position.

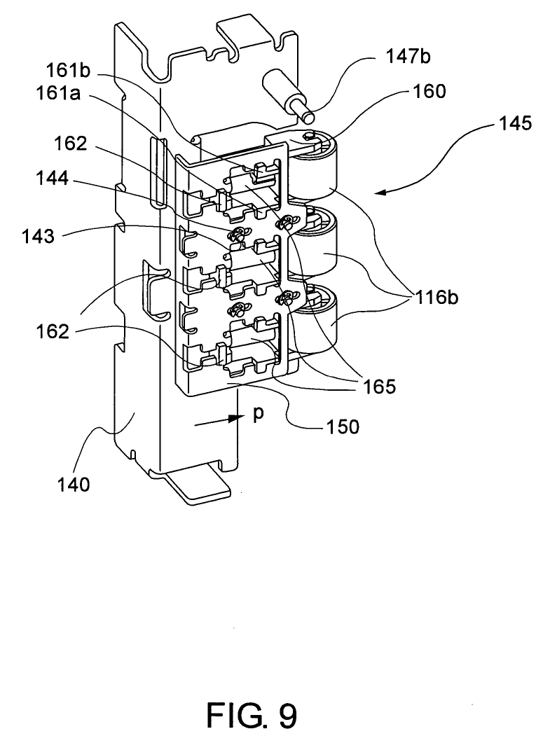

The pressure frame 150 applies pressure to the pressure rollers 116b through an intervening elastic member 165 (see FIG. 9 to FIG. 13). Therefore, when the transportation path opening/closing block 130 is closed, the pressure rollers 116b are urged with specific force against the feed rollers 116a, and the transportation roller pairs 116 hold the first or second transported medium 2, 15 with a specific holding force.

When the transportation path opening/closing block 130 is opened, the pressure engaging portion 135 separates from the pressure frame 150. The pressure pushing the pressure frame 150 in the direction of the transportation path 112 is thus released, the pressure on the pressure rollers 11 6b is released, and the holding force of the transportation roller pairs 116 is released.

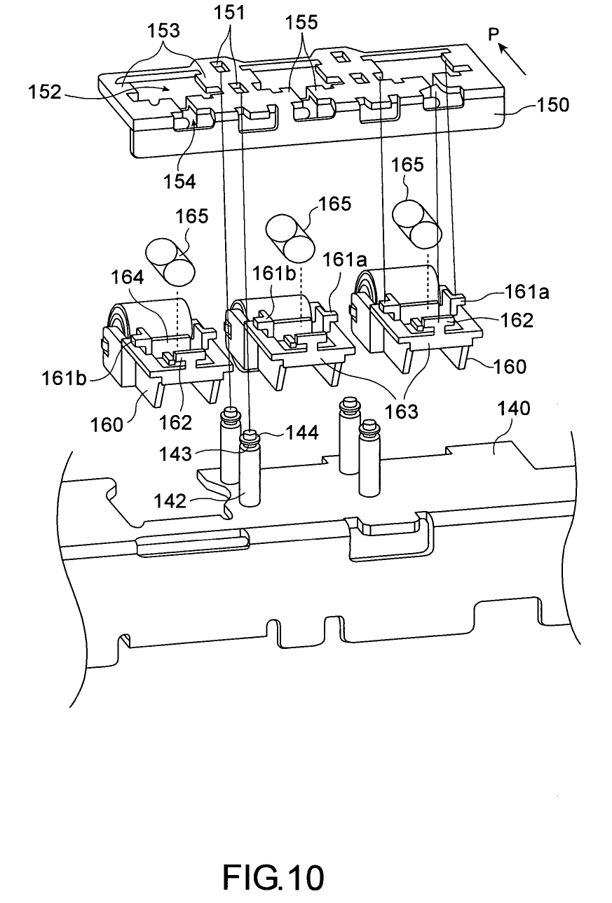

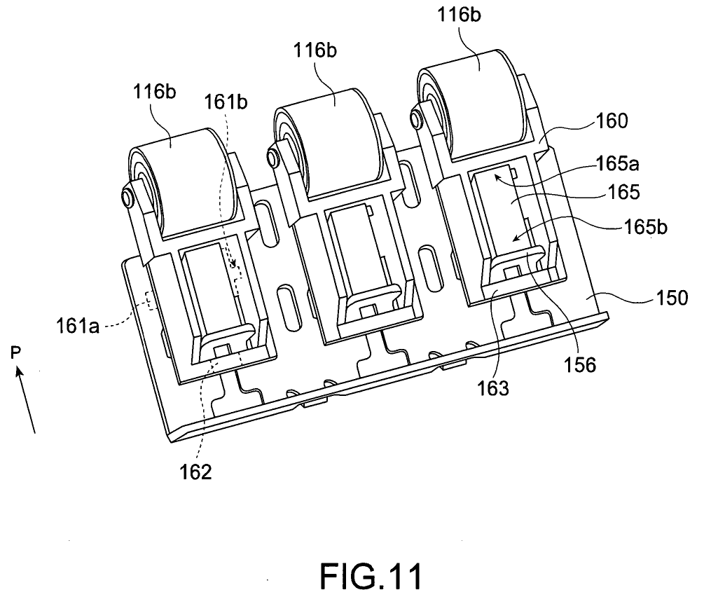

FIG. 9 is an oblique view of the roller pressure block 145 assembled to the main frame 140. FIG. 10 is an exploded oblique view showing the structure for assembling the pressure frame 150 and roller holding members 160 of the roller pressure block 145 to the main frame 140. FIG. 11 is an oblique view showing the assembly of the roller holding members 160 and pressure frame 150 from the opposite side shown in FIG. 9. Arrow P in FIG. 9 to FIG. 13 shows the direction in which the pressure frame 150 is pushed and moved by the pressure engaging portion 135 when the transportation path opening/closing block 130 closes.

As shown in FIG. 10, support studs 142 each having a pin 143 on the exposed end are disposed to the main frame 140. Slide holes 151 in the pressure frame 150 are fit onto these pins 143, and the pressure frame 150 is then secured by means of clips 144 (see FIG. 9). The pressure frame 150 is thus supported on support studs 142 fixed to the main frame 140, and can slide on the support studs 142 along the slide holes 151.

The roller holding members 160 are attached to the pressure frame 150. The pressure rollers 116b are rotatably axially supported by roller shafts 116c on the distal ends of the roller holding members 160. A roller holding member 160 is provided for each pressure roller 116b. In this embodiment of the invention three pressure rollers 116b are assembled to the pressure frame 150 through three corresponding roller holding members 160.

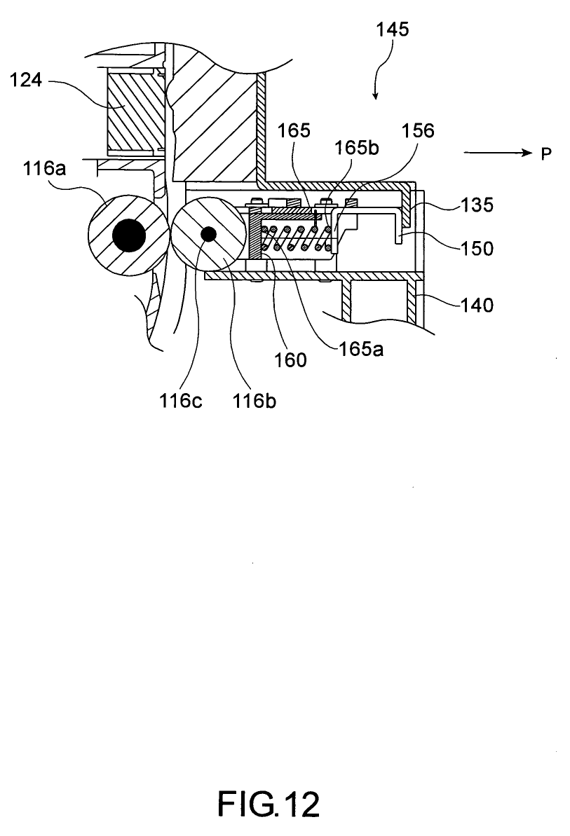

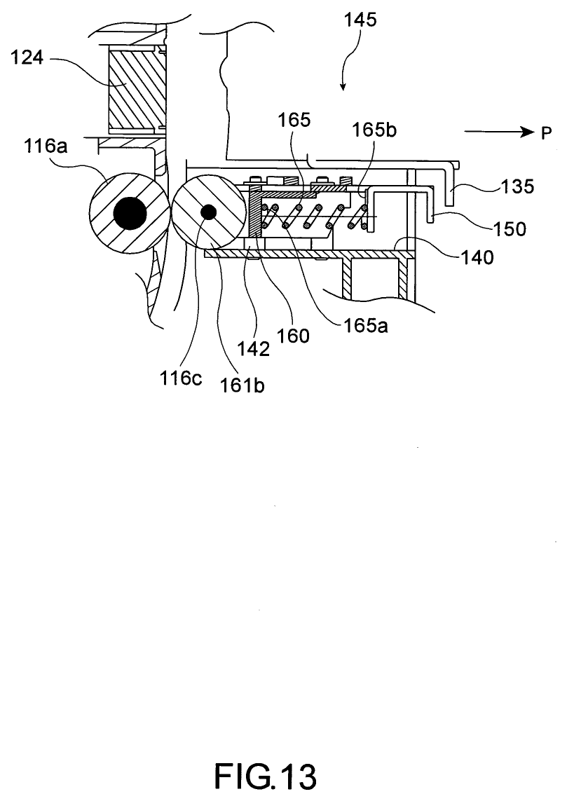

Each roller holding member 160 has first engaging tabs 161a, 161b, and second engaging tab 162. The first engaging tabs 161a, 161b pass through holes 152 in the pressure frame 150 and engage the top of the first sliding surface 153. The second engaging tab 162 passes through through-hole 154 and engages the second sliding surface 155. A compression spring (elastic member) 165 is fit between the pressure frame 150 and the roller holding members 160 inside opening 164. See FIG. 12 and FIG. 13.

FIG. 11 is an oblique view from the back side of the pressure frame 150 when the pressure frame 150 and roller holding members 160 are assembled. The compression spring 165 is installed with one end 165a (the “front end” below) in contact with the roller holding members 160 and the other end 165b (the “back end” below) against a spring pressure base 156 protruding from the pressure frame 150 to the back.

When the transportation path opening/closing block 130 is closed, the pressure engaging portion 135 and pressure frame 150 engage, and the pressure frame 150 is pressed by the pressure engaging portion 135 and moves to a specific position. See FIG. 8, FIG. 12, and FIG. 13.

When the transportation path opening/closing block 130 is closed, the pressure engaging portion 135 pushes and slides the pressure frame 150 in the direction of the transportation path 112. The spring pressure base 156 thus moves in the direction of the pressure rollers 116b, and pushes against the back end 165b of the spring 165. When pressure is thus applied to the back end 165b of the spring 165, the front end 165a pushes against the roller holding members 160.

Because the roller holding members 160 cannot move when the pressure rollers 116b contact the feed rollers 116a, the spring 165 is compressed by the spring pressure base 156 in conjunction with the pressure frame 150 sliding.

When the transportation path opening/closing block 130 is closed and the pressure engaging portion 135 moves to a specific closed position, the spring 165 is compressed a predetermined amount. The pressure rollers 116b are thus urged with a specific pressure load to the feed rollers 116a, and the transportation roller pairs 116 thus exert a specific holding force.

In other words, closing the transportation path opening/closing block 130 causes the pressure frame 150 to slide. This causes the spring 165 to compress, and the resulting force of the compressed spring exerts a specific pressure load on the corresponding pressure roller.

FIG. 12 is a section view of when the transportation path opening/closing block 130 is closed. In this position the pressure engaging portion 135 of the transportation path opening/closing block 130 engages the pressure frame 150 of the roller pressure block 145. Because the spring 165 is compressed by the spring pressure base 156, the pressure frame 150 is urged by the spring 165 to the right as seen in FIG. 12.

However, because the pressure engaging portion 135 limits movement to the right, the pressure frame 150 cannot move to the right. In reaction, therefore, the force of the spring 165 is applied to the roller holding member 160 by way of the front end 165a of the spring 165 in contact with the roller holding member 160. Furthermore, because the roller holding members 160 can slide relative to the pressure frame 150, the roller holding members 160 is urged and moves to the left. The pressure roller 116b axially supported via roller shaft 116c on the distal end of the roller holding member 160 is thus pressed to the opposing feed roller (drive roller) 116a.

As a result, a holding force determined by the spring constant of coil spring 165 is produced between the feed roller 116a and pressure roller 116b. Note that because the pressure engaging portion 135 is always positioned to the same position when the transportation path opening/closing block 130 is closed, the transportation roller pairs 116 always maintain the same holding force.

FIG. 13 is a section view of the roller pressure block 145 when the transportation path opening/closing block 130 is opened slightly.

When the transportation path opening/closing block 130 opens, the pressure engaging portion 135 moves to the right as seen in FIG. 13. As described with reference to FIG. 9 and FIG. 10, the pressure frame 150 can slide laterally as seen in the figure. Therefore, when the pressure engaging portion 135 moves to the right, the pressure frame 150 also moves to the right due to the elastic force of the spring 165. The spring 165 thus expands and exerts less force.

In reaction to the expansion of the spring 165, the pressure of the pressure rollers 116b on the feed rollers 116a weakens, and the holding force of the transportation roller pairs 116 is reduced. How much the holding force of the transportation roller pairs 116 is reduced as a result of opening the transportation path opening/closing block 130 can be determined by controlling the sliding range of the pressure frame 150. More specifically, the farther the pressure frame 150 can move to the right (the longer the spring 165 can expand) when the transportation path opening/closing block 130 is completely separated from the pressure frame 150, the weaker the holding force becomes. The sliding range of the pressure frame 150 is controlled by the length of the slide holes 151. Therefore, the holding force can be completely removed by enabling the pressure frame 150 to slide a distance greater than the free length of the spring 165.

When the transportation path opening/closing block 130 is thus released, the pressure engaging portion 135 moves to the right, and the force of the springs 165 causes the pressure frame 150 to move to the right. As a result, the springs 165 expand, the pressure applied to the pressure rollers 116b weakens, and the holding force of the transportation roller pairs 116 is relieved. If a paper jam occurs and the first transported medium 2 is held by the transportation roller pairs 116, the holding force of the transportation roller pairs 116 can thus be released by opening the transportation path opening/closing block 130, and the paper jam can be easily removed.

While a coil spring 165 is used as the elastic member pressing the pressure rollers 116b to the feed rollers 116a in the foregoing embodiment, a torsion spring, flat spring, or other type of spring or other elastic member could be used instead.

The release mechanism for transportation roller pair 115, referred to as the second transportation roller release mechanism below, is described next.

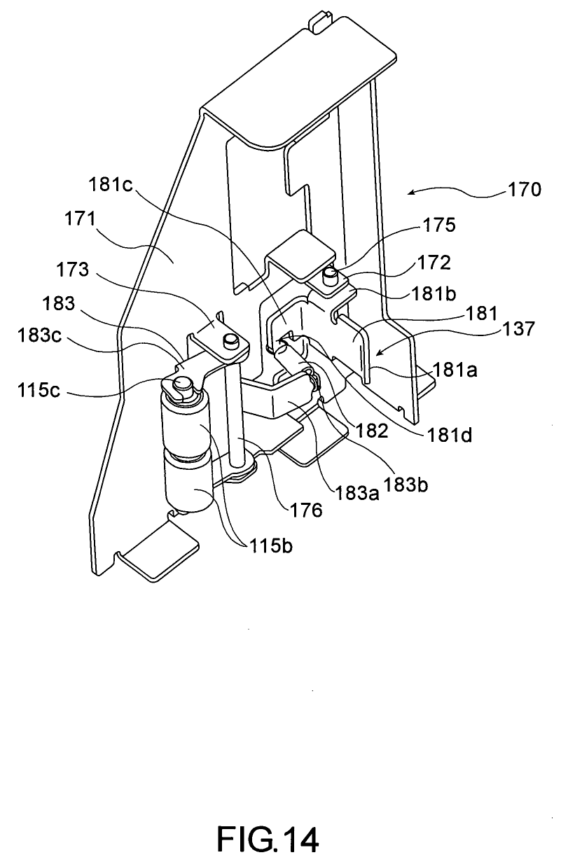

The second transportation roller release mechanism in this embodiment of the invention has a rotating arm 181 that is pivoted by the opening/closing operation of the transportation path opening/closing block 130, increases or decreases the elastic load applied to the pressure roller 115b by means of the rotating action of the rotating arm 181, and thus adjusts the holding force of the transportation roller pair 115. This second transportation roller release mechanism is well suited to arrangements in which the transportation roller pair 115 and transportation path opening/closing block 130 are disposed with a curved portion of the U-shaped transportation path 112 therebetween. FIG. 14 is an oblique view of the roller opening/closing block 170 according to a preferred embodiment of this second transportation roller release mechanism. This roller opening/closing block 170 includes an opening/closing block frame 171 fixed to the main frame, a rotating arm 181 rotatably supported on the opening/closing block frame 171, and a roller support arm 183 supporting the pressure roller 115b.

The rotating arm 181 is rotatably supported by a pivot pin 175 fixed to the axial support portion 172 of the opening/closing block frame 171. The rotating arm 181 has an engagement end portion 181b and a catch end portion 181c. The engagement end portion 181b has an engaging surface 181a that contacts the pivoting engagement portion 137 of the transportation path opening/closing block 130, and one end of an extension spring 182 is caught on the distal end 181d of the catch end portion 181c.

The roller support arm 183 is rotatably supported by a pivot pin 176 fixed to the pin support portion 173 of the opening/closing block frame 171. The pressure roller 115b axially supported by a rotary shaft 115c is supported on the roller support end 183c of the roller support arm 183, and the other end of the extension spring 182 is attached to the distal end 183b of the catch end portion 183a at the opposite end from the roller support end 183c.

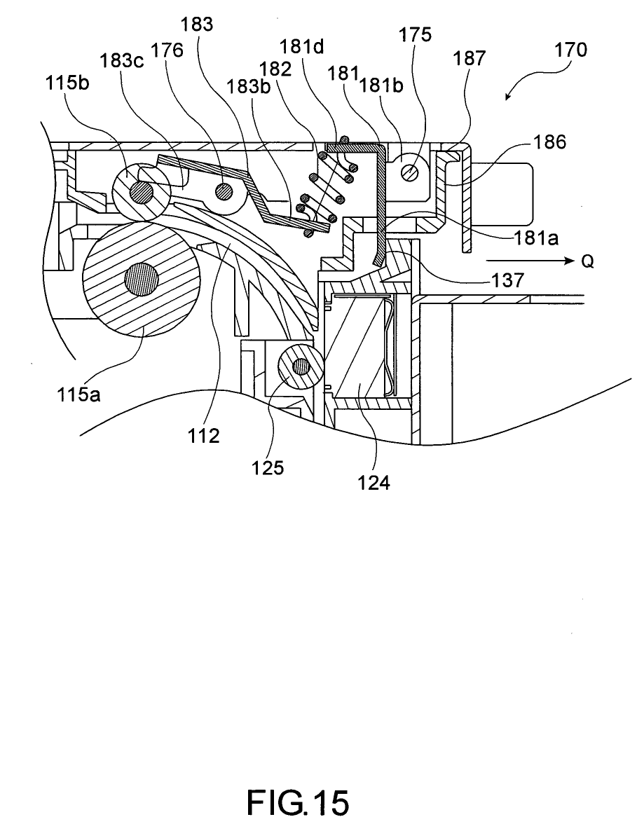

When the transportation path opening/closing block 130 is closed, the pivoting engagement portion 137 (see FIG. 7) of the transportation path opening/closing block 130 moves from the direction of arrow Q shown in FIG. 15, and engages and applies pressure to the engaging surface 181a, causing the rotating arm 181 to rotate clockwise. The rotating arm 181 thus rotates clockwise. When the rotating arm 181 rotates clockwise, the roller support arm 183 is urged to rotate counterclockwise by means of the intervening extension spring 182, one end of which is attached to the distal end 183b of the catch end portion 183a. The pressure roller 115b is thus urged with specific force to the drive roller 115a.

FIG. 15 is a partial section view of the roller opening/closing block 170 when the transportation path opening/closing block 130 is closed. The opening/closing block frame 171 is omitted for a better view.

When the transportation path opening/closing block 130 is closed, the pivoting engagement portion 137 of the transportation path opening/closing block 130 presses against the engaging surface 181a and causes the rotating arm 181 to rotate clockwise.

However, the pressure roller 115b supported on the roller support end 183c of the roller support arm 183 cannot rotate counterclockwise because the pressure roller 115b is pressed against the drive roller 115a. The rotating arm 181 and roller support arm 183 are also linked by the extension spring 182. More specifically, the extension spring 182 is mounted between the distal end 181d of the catch end portion 181c of the rotating arm 181, and the distal end 183b of the catch end portion 183a of the roller support arm 183.

If the rotating arm 181 rotates clockwise from this position, a counterclockwise torque is applied to the roller support arm 183 by the intervening extension spring 182. However, counterclockwise rotation is limited by the drive roller 115a, and the roller support arm 183 therefore cannot rotate. As a result, the extension spring 182 is stretched in conjunction with counterclockwise rotation of the rotating arm 181, and the resulting spring tension is transferred by the roller support arm 183 to the pressure roller 115b.

The pivoting engagement portion 137 always stops at a constant position when the transportation path opening/closing block 130 is closed. The tension of the extension spring 182 is therefore also constant, and the holding force of the transportation roller pair 115 can therefore also be kept constant.

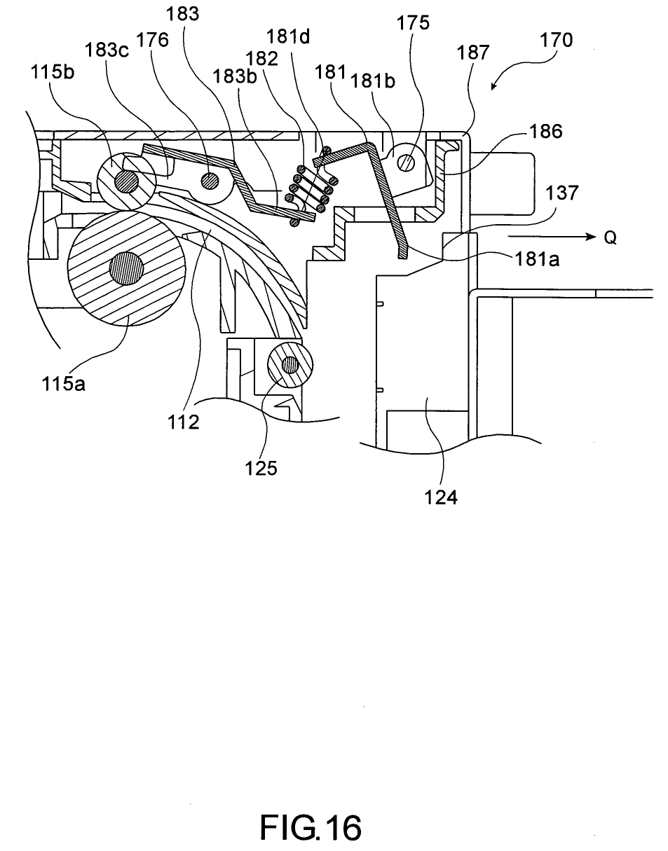

Operation when the transportation path opening/closing block 130 opens is described next. FIG. 16 is a partial section view showing the roller opening/closing block 170 when the transportation path opening/closing block 130 is opened.

When the transportation path opening/closing block 130 opens, the transportation path opening/closing block 130 and pivoting engagement portion 137 move in the direction of arrow Q. The pivoting engagement portion 137 thus separates from the engaging surface 181a of the rotating arm 181.

When the pivoting engagement portion 137 separates from this engaging surface 181a, the rotating arm 181 rotates counterclockwise due to the tension of the extension spring 182. The tension of the extension spring 182 thus decreases, and the pressure of the pressure roller 115b also decreases.

The holding force of the transportation roller pair 115 thus also decreases, and a first transported medium 2 held between the transportation roller pair 115 when a paper jam occurs can be easily removed without damaging the first transported medium 2.

The foregoing roller opening/closing block 170 is described with reference to a transportation roller set 115 having one drive roller 115a and one pressure roller 115b, but the second transportation roller release mechanism of the present invention can obviously be applied to transportation roller sets having multiple feed (drive) rollers and pressure rollers.

In this case the roller opening/closing block could have multiple rotating arms 181, extension springs 182 or other elastic means, and roller support arms 183 determined according to the number of pressure rollers, or it could have one rotating arm 181 and one roller support arm 183 supporting the multiple pressure rollers. In the latter case the number and location of the elastic members connecting the rotating arm 181 and roller support arm 183 can be suitably determined to apply the desired elastic load on the pressure rollers and balance the load on each pressure roller.

Furthermore, the roller support arm 183 is a pivoting arm in this embodiment of the invention, but could be configured so that the rotary action of the rotating arm 181 causes the roller pressure arm to slide linearly by way of an intervening elastic member. For example, when the rotating arm 181 pivots, one end thereof could apply pressure to the elastic member, producing an elastic load causing the roller pressure arm to slide so that the pressure produced by the elastic member is applied to the pressure roller.

The transportation path opening/closing mechanism according to the foregoing second embodiment of the invention is described with reference to a transportation path opening/closing mechanism for an image reading apparatus 110 having two scanners for imaging both sides of the first or second transported medium 2, 15. It will be obvious, however, that this transportation path opening/closing mechanism can also be adapted for implementations having only one scanner for imaging one side of the transported medium, and implementations having three or more scanners.

This embodiment of the invention is also described using by way of example an implementation having an MICR, but the invention can obviously be applied to implementations not having an MICR, and to implementations having a printer (information recording unit) for printing to the transported medium.

This embodiment is also described having a straight transportation path in addition to the U-shaped transportation path, but could obviously have only a U-shaped transportation path.

Yet further, the scanners are disposed to the straight part of the transportation path located between the two curved parts of the U-shaped transportation path in this embodiment of the invention, but the invention can obviously also be used when the scanners are located in a different part of the transportation path.

The transportation path opening/closing mechanism of the present invention shall obviously not be limited to the foregoing embodiment, and various implementations that release the holding force of transportation rollers adjacent to the open portion of the transportation path in conjunction with the action of a transportation path opening/closing mechanism that opens part of a U-shaped transportation path are possible.

Furthermore, the transportation path opening/closing mechanism according to the foregoing embodiment of the invention has both first and second transportation roller release mechanisms, but could alternatively have only one of these transportation roller release mechanisms.

### Third Embodiment

An image reading apparatus 210 having a transportation path opening/closing mechanism according to a third embodiment of the present invention is described in detail next.

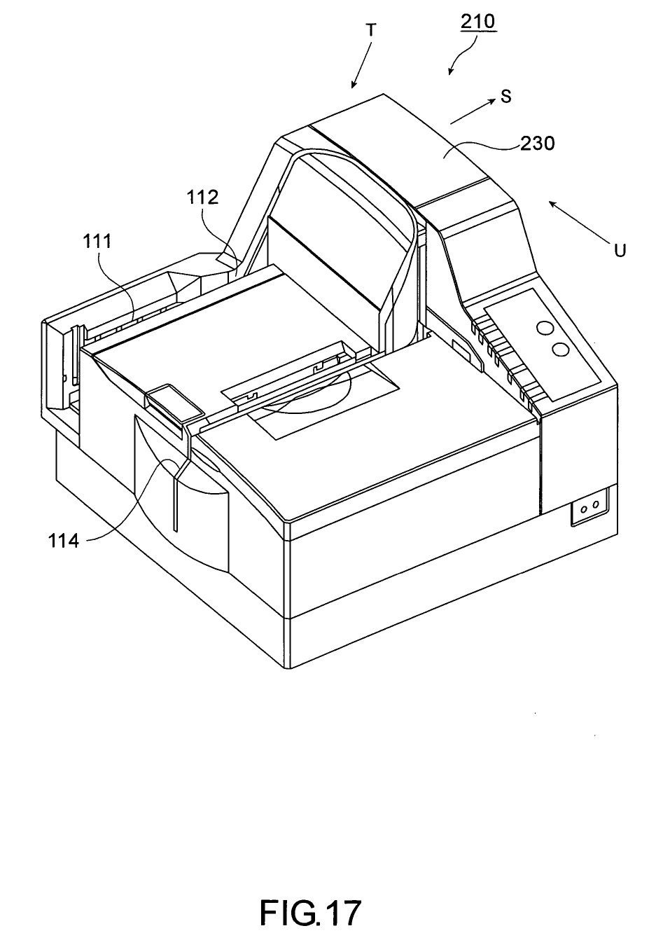

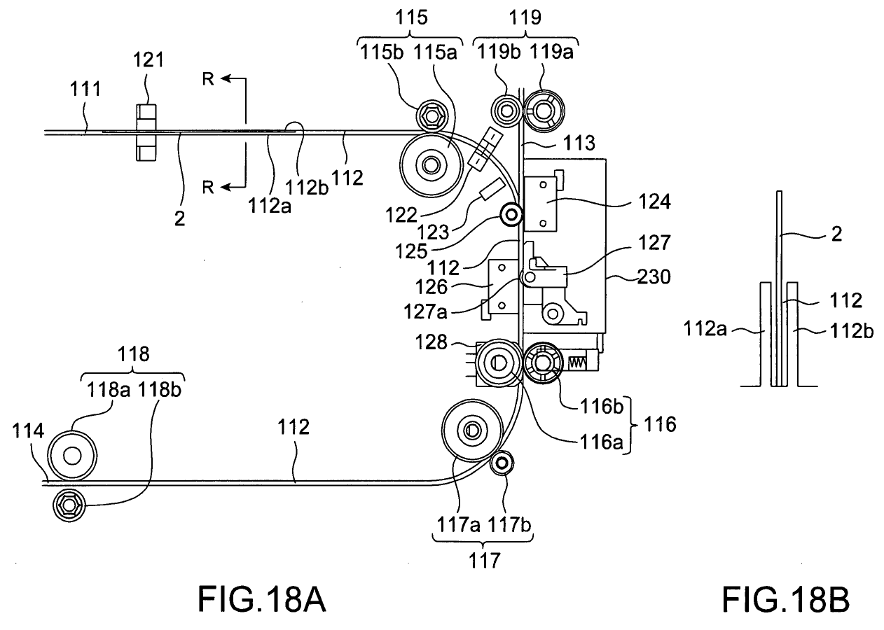

FIG. 17 is an oblique external view of the image reading apparatus 210 according to this third embodiment of the invention. FIG. 18A is a schematic plan view of the transportation path and various parts disposed neighboring the transportation path in the image reading apparatus 210 shown in FIG. 17. FIG. 18B is a section view through R-R in FIG. 18A.

The image reading apparatus 210 according to this third embodiment of the invention is substantially the same as the image reading apparatus 110 according to the foregoing second embodiment, differing therefrom in the configuration of the transportation path opening/closing mechanism. Like parts are therefore identified by the same reference numerals, and further description thereof is omitted below.

The transportation path opening/closing mechanism according to this third embodiment has a transportation path opening/closing block 230 for opening/closing a portion of the U-shaped transportation path 112. This transportation path opening/closing block 230 opens in the direction indicated by arrow S in FIG. 17.

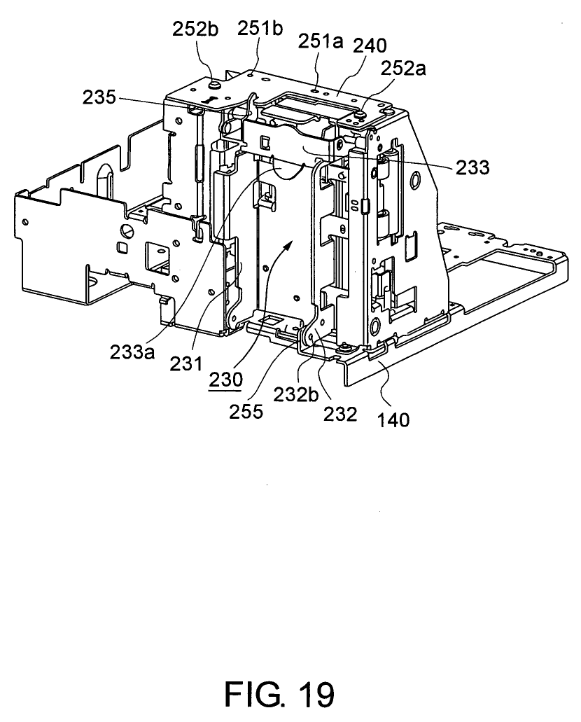

As shown in FIG. 19 to FIG. 21, the transportation path opening/closing block 230 is disposed to the outside guide wall 112b side of the U-shaped transportation path 112 in this third embodiment. When a paper jam occurs or to clean the first and second image readers 124, 126, the transportation path opening/closing block 230 can be opened to the outside to expose a part of the transportation path 112.

The top of the transportation path 112 and straight transportation path 113 is covered by a cover member 240. This cover member 240 functions to maintain the gap between the inside guide wall 112a and outside guide wall 112b within a specified dimensional tolerance by means of engagement pins 251a, 251b disposed to the inside guide wall 112a, and screws 252a, 252b fixed to the outside guide wall 112b.

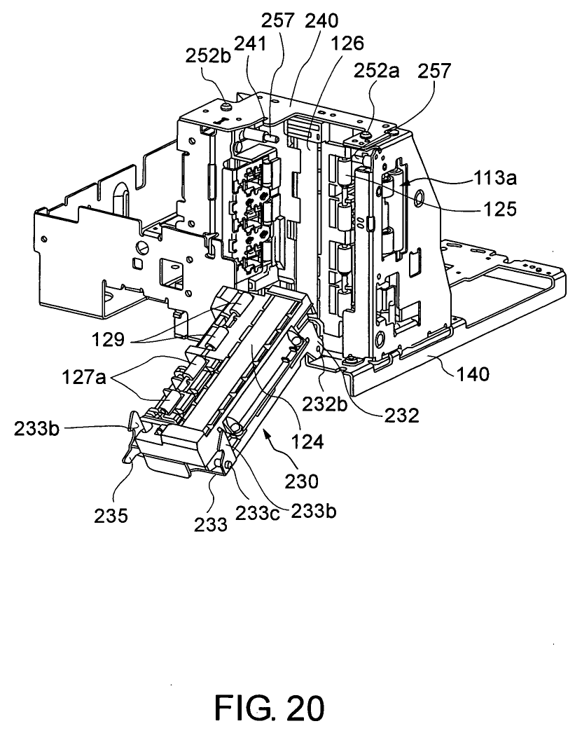

Pulling lever 233a of the transportation path opening/closing block 230 forward disengages the hooks 233b and thereby releases and allows the transportation path opening/closing block 230 to open as shown in FIG. 20.

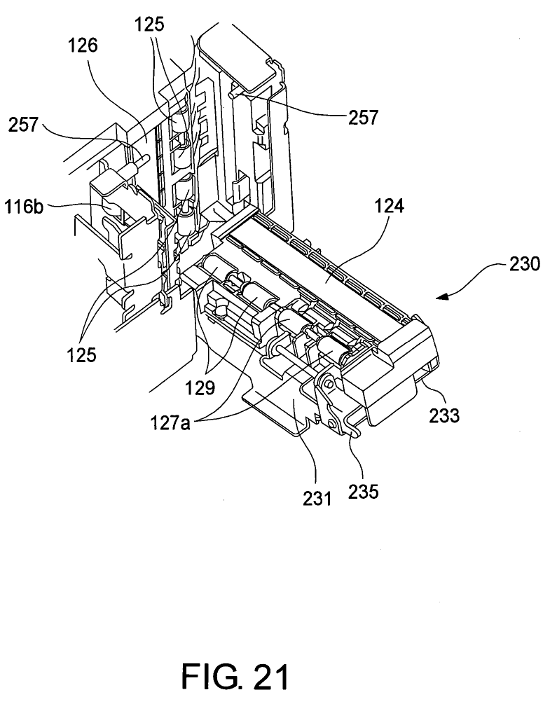

FIG. 20 and FIG. 21 show the transportation path opening/closing block 230 swung approximately 90 degrees to the outside so that part of the transportation path 112 is open. Thus opening the transportation path opening/closing block 230 exposes part of the transportation path 112 and the first and second image readers 124, 126.

As a result, a paper jam can be easily removed and the first and second image readers 124, 126 can be easily cleaned.

The transportation path opening/closing block 230 has an opening/closing lever member 233, and an opening/closing wall 231 that is also part of the outside guide wall 112b. The bottom part of the opening/closing wall 231 is pivotably attached to the main frame 140.

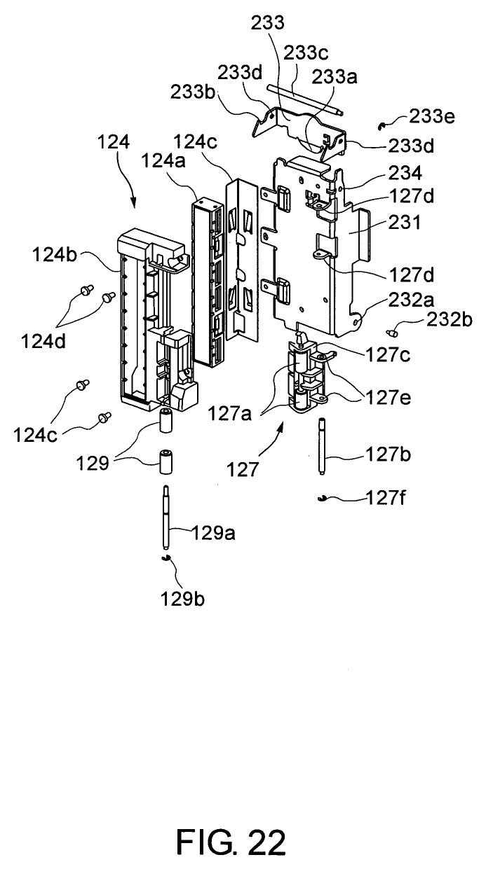

FIG. 22 is an exploded oblique view of the transportation path opening/closing block 230. The first image reader 124, pressure mechanism 127, and pressure rollers 129 are assembled to the opening/closing wall 231, which is part of the outside guide wall 112b.

Holes 232a are formed in the pivot shaft holder 232 and attached to the main frame 140 of the image reading apparatus 210 by pivot pins 232b. The pivot joint thus formed allows the opening/closing wall 231 to open and close by swinging on these pivot pins 232b similarly to a door.

When the opening/closing wall 231 closes, the first image reader 124 is opposite the pressure rollers 125, and the pressure mechanism 127 for pressing the second transported medium 15 to the scanning surface of the second image reader 126 when imaging the second transported medium 15 is opposite the second image reader 126.

Lever bearing holes 234 are rendered in the top part of the opening/closing wall 231, and bearing holes 233d are also formed in the opening/closing lever member 233. A pivot shaft 233c is inserted through these holes 234, 233d, and is secured by clips 233e. The opening/closing lever member 233 is thus attached to the opening/closing wall 231 so that the opening/closing lever member 233 can move rotationally on the pivot shaft 233c. The opening/closing lever member 233 is further urged clockwise as seen in FIG. 21 by an elastic member not shown.

When the transportation path opening/closing block 230 closes, the inclined surfaces of the hooks 233b contact support pins 257, and the opening/closing lever member 233 thus rotates counterclockwise against the elastic force of the elastic member. When the transportation path opening/closing block 230 closes to a specific position, the support pins 257 slip into the recessed part of the hooks 233b, and the opening/closing lever member 233 rotates clockwise due to the tension of the elastic member not shown. As a result, the hooks 233b are held by the support pins 257. The transportation path opening/closing block 230 is thus locked in a specific position.

To open the transportation path opening/closing block 230, the lever 233a is pulled forward, thereby rotating the opening/closing lever member 233 in the opposite (counterclockwise) direction. The lock is thus disengaged, the transportation path opening/closing block 230 opens, and part of the U-shaped transportation path 112 can be exposed.

The first image reader 124 is attached by a hinge or screws 124d to the opening/closing wall 231 with the first scanner element 124a disposed between the sheet member 124c and scanner cover 124b. A pair of mounting brackets 127d is formed on the opening/closing wall 231 adjacent to the top of the first image reader 124. The pressure mechanism 127 is attached to these mounting brackets 127d by a pivot shaft 127b. The pressure mechanism 127 has a movable bracket 127c, and pressure rollers 127a rotatably assembled to the movable bracket 127c.

The pressure mechanism 127 is rotatably mounted to the mounting brackets 127d by the pivot shaft 127b, which is set into bearing holes 127e formed in the movable bracket 127c. The pressure mechanism 127 is urged counterclockwise as seen in FIG. 21 by an elastic member not shown so that the pressure rollers 127a are pressed to the second image reader 126.

Pressure rollers 129 are rotatably mounted by rotary shaft 129a to the bottom right portion of the scanner cover 124b in order to smoothly transport the first transported medium 2. The rotary shaft 129a is secured by clips 129b.

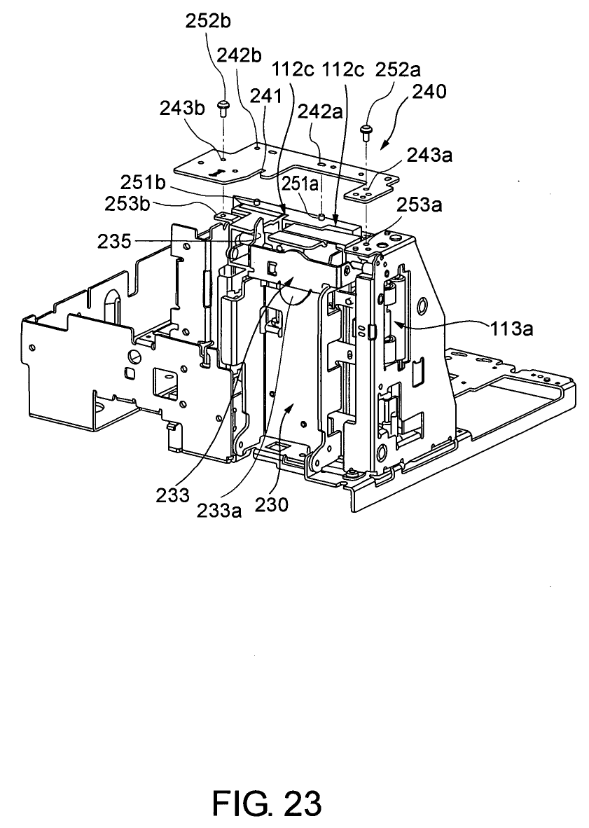

The cover member 240 of the image reading apparatus 210 according to this third embodiment of the present invention is described next with reference to FIG. 23.

As shown in FIG. 23, the cover member 240 of an image reading apparatus 210 according to this third embodiment of the invention is shaped to cover the top opening 112c of the U-shaped transportation path 112 where the first and second image readers 124, 126 are located.

The cover member 240 is fixed by means of the engagement pins 251a, 251b in the inside guide wall 112a, and screws 252a, 252b. The engagement pins 251a, 251b are inserted into the pin-receiving holes 242a, 242b in the cover member 240.

The screws 252a, 252b pass through through-holes 243a, 243b in the cover member 240, and are screwed into screw holes 253a, 253b in the outside guide wall 112b. The cover member 240 is thus fixed to the U-shaped transportation path 112 and closes the top opening 112c in this portion of the U-shaped transportation path 112.

The cover member 240 joins the inside guide wall 112a and outside guide wall 112b with a specific gap therebetween, and by making the cover member 240 from a relatively strong, rigid material (which could be as rigid as plastic), the cover member 240 functions to maintain this gap between the inside guide wall 112a and outside guide wall 112b within a specific dimensional tolerance.

The cover member 240 also has a positioning groove 241. When the transportation path opening/closing block 230 is closed, a positioning bar 235 disposed to the transportation path opening/closing block 230 engages this positioning groove 241 and thus stops the transportation path opening/closing block 230 in the correct position. The correct dimensional tolerance can thus be maintained in the transportation path in the area where the transportation path opening/closing block 230 is located.

The image reading apparatus having a transportation path opening/closing mechanism according to the foregoing third embodiment of the invention is described as having two scanners for imaging both sides of the transported medium. It will be obvious, however, that this transportation path opening/closing mechanism can also be adapted for implementations having only one scanner for imaging one side of the transported medium, and implementations having three or more scanners.

This embodiment of the invention is also described using by way of example an implementation having an MICR, but the invention can obviously be applied to implementations not having an MICR, and to implementations having a printer (information recording unit) for printing to the transported medium.

This embodiment is also described having a straight transportation path in addition to the U-shaped transportation path, but could obviously have only a U-shaped transportation path.

Yet further, the scanners are disposed to the straight part of the transportation path located between the two curved parts of the U-shaped transportation path in this embodiment of the invention, but the invention can obviously also be used when the scanners are located in a different part of the transportation path.

### Fourth Embodiment

An image reading apparatus 310 having a transportation path opening/closing mechanism according to a fourth embodiment of the present invention is described in detail next.

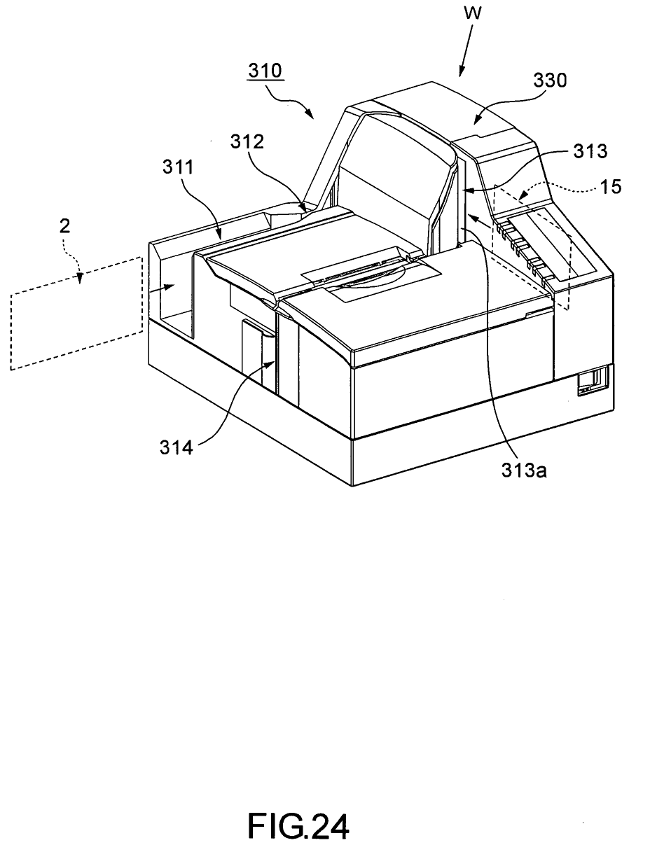

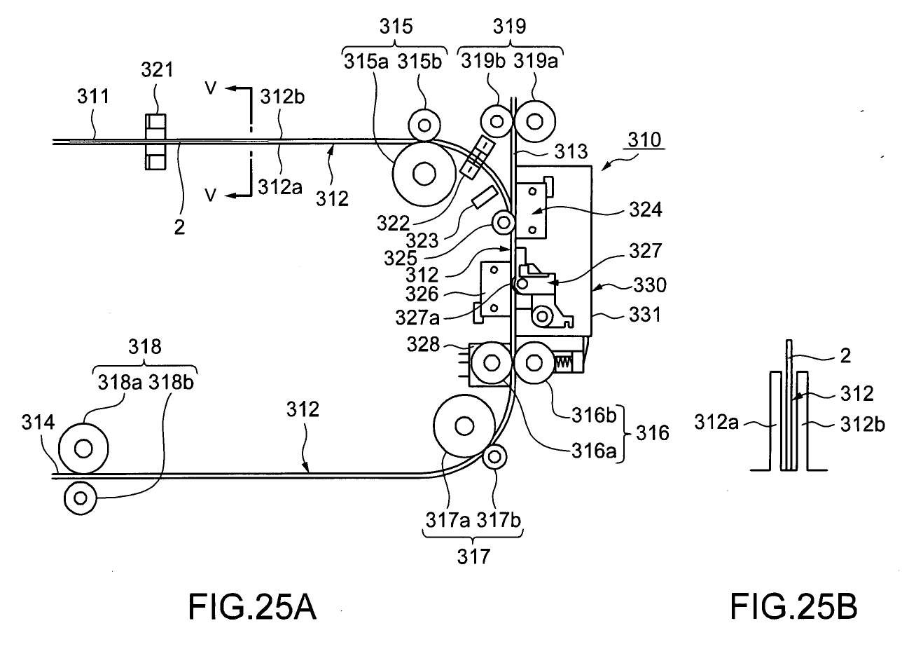

FIG. 24 is an oblique external view of the image reading apparatus 310 having a transportation path opening/closing mechanism according to this fourth embodiment of the invention. FIG. 25A is a schematic plan view of the transportation path and various parts disposed neighboring the transportation path in the image reading apparatus 310 shown in FIG. 24. FIG. 25B is a section view through V-V in FIG. 25A.

This image reading apparatus 310 has a loading unit 311 to which checks, slips, or other first transported medium 2 are inserted, a U-shaped transportation path 312 for conveying the inserted first transported medium 2, and an exit 314 for discharging the first transported medium 2 after reading or other processing is completed. A transportation path opening/closing block 330 for opening part of the transportation path 312 is also disposed to the transportation path 312.

As shown in FIG. 25A, an image reading apparatus 310 according to this fourth embodiment of the invention has a U-shaped transportation path 312 for conveying a first transported media 2 such as checks, and a straight transportation path 313 for conveying second transported media 15 such as ID cards and driver licenses.

This straight transportation path 313 shares the straight part between the two curved parts of the U-shaped transportation path 312. This straight transportation path 313 is rendered at a higher elevation than the transportation path 312, and second transported media 15 are thus conveyed at a higher elevation than first transported media 2.

Disposed along the transportation path 312 in this image reading apparatus 310 in sequence from the loading unit 311 are a paper detector 321, transportation roller pair 315, magnet 323, two contact image scanners (CIS) or other type of image reader (information reading units) 324 and 326, pressure rollers 325 and pressure mechanism 327 for pressing the first transported medium 2 to the image readers 324, 326, transportation roller pair 316, MICR (magnetic ink character reader) head 328 disposed below the transportation roller pair 316, and transportation roller pair 317, and transportation roller pair 318 for conveying the first transported medium 2 to the exit 314.

The two image readers 324, 326 are located on opposite sides of the transportation path 312 so that one images the front side of the first or second transported medium 2, 15 and the other images the back side of the first or second transported medium 2, 15.

Note that only four transportation roller pairs 315, 316, 317, and 318 are shown in FIG. 25A to simplify the description, but feed rollers could also obviously be disposed near the loading unit 311 to feed the inserted first transported medium 2 into the transportation path 312.

A printer could also be disposed to the U-shaped transportation path 312 between the MICR head 328 and exit 314 for printing to the front and back of the first transported medium 2.

The transportation path 312 is described next.

As shown in FIG. 25B, the transportation path 312 has an inside guide wall 312a and an outside guide wall 312b for guiding the first transported medium 2 on both sides. The space between these walls 312a and 312b is the U-shaped transportation path 312, and the first transported medium 2 is conveyed through this space.

In the straight part of the U-shaped transportation path 312 from the loading unit 311 to the transportation roller pair 315 on the upstream side of the first curved part of the transportation path, and in the straight part from transportation roller pair 317 to the exit 314, the height of the inside guide wall 312a and outside guide wall 312b as measured from the bottom of the transportation path 312 is less than the height K of the first transported medium 2 as shown in FIG. 25B.

The first transported medium 2 is thus conveyed through the U-shaped transportation path 312 with the top part of the medium 2 exposed above the top of the U-shaped transportation path 312 near the loading unit 311 and the exit 314. As a result, the first transported medium 2 can be relatively easily removed if a paper jam occurs in these areas.

When the paper detector 321 detects a first transported medium 2 inserted from the loading unit 311, the first transported medium 2 is conveyed into the transportation path 312 by transportation rollers or feed rollers not shown, and is sequentially conveyed through the U-shaped transportation path 312 at a specific speed by the transportation roller pairs 315 to 318.

These transportation roller pairs 315 to 318 each include a drive roller (feed roller) 315a to 318a and a pressure roller 315a to 318b. The feed rollers 315a to 318a are located on the inside circumference side of the U-shaped transportation path 312 and are rotationally driven by a drive source (motor) not shown. The pressure rollers 315b to 318b are located on the outside circumference side of the U-shaped transportation path 312, and press the first transported medium 2 to the feed rollers 315a to 318a. The transportation roller pairs 315 to 318 thus convey a first transported medium 2 held between the feed rollers 315a to 318a and pressure rollers 315b to 318b in the direction in which the feed rollers 315a to 318a rotate.

When a first transported medium 2 travelling through the U-shaped transportation path 312 is detected by the paper detector 322 disposed upstream of the first image reader 324, the output detection signal triggers the reading processes timed to the first transported medium 2 passing the first image reader 324, second image reader 326, and MICR head 328.

If the first transported medium 2 is a check or other medium having information recorded using magnetic ink characters, the magnetic ink characters are magnetized by the magnet 323 located downstream of the transportation roller pair 315 as the first transported medium 2 passes thereby, and the magnetic ink character information can thus be read by the MICR head 328.

A first transported medium 2 inserted from the loading unit 311 to the U-shaped transportation path 312 is thus imaged on both sides by the first image reader 324 and second image reader 326 as the first transported medium 2 passes thereby. In addition, if the first transported medium 2 has magnetic ink characters printed thereon, the information recorded by the magnetic ink characters is read by the MICR head 328. The first transported medium 2 is then discharged from the exit 314 with the direction of travel changed 180 degrees as the first transported medium 2 traverses the transportation path.

The imaging process of the first and second image readers 324, 326 is described in detail next.

The first image reader 324 is disposed on the outside guide wall 312b side with the scanning surface facing the U-shaped transportation path 312. The pressure rollers 325 are disposed on the inside guide wall 312a side at a position opposite the first image reader 324 with the U-shaped transportation path 312 therebetween. The conveyed first transported medium 2 is pressed by the pressure rollers 325 to the scanning surface of the first image reader 324. As a result, the one side of the first transported medium 2 facing the scanning surface is imaged as the first transported medium 2 passes pressed to the scanning surface of the first image reader 324.

The second image reader 326 is located on the inside guide wall 312a side downstream from the first image reader 324 with the scanning surface of the second image reader 326 facing the U-shaped transportation path 312. The pressure mechanism 327 is located on the outside guide wall 312b side at a position opposite the second image reader 326 with the transportation path 312 therebetween. Pressure rollers 327a are disposed to the distal end of the pressure mechanism 327, and these pressure rollers 327a press a first transported medium 2 travelling through the U-shaped transportation path 312 to the scanning surface of the second image reader 326. As a result, the other side of the first transported medium 2 is imaged by the second image reader 326 as the first transported medium 2 passes thereby pressed to the scanning surface.

In order to capture a complete image of the entire first transported medium 2, the height of the scanning surface of the first and second image readers 324, 326 forming part of the U-shaped transportation path 312, and the height of the inside guide wall 312a and outside guide wall 312b in the image scanning area where the first and second image readers 324, 326 are located and image the transported medium, are greater than the height K of the first transported medium 2 as shown in FIG. 24.

A first transported medium 2 travelling through this image scanning area is thus completely covered on both sides by the inside guide wall 312a and outside guide wall 312b, and the first transported medium 2 is thus hidden inside the transportation path 312.

If a paper jam occurs in this image scanning area, the jammed first transported medium 2 cannot be touched because the inside of the transportation path cannot be accessed, and the paper jam therefore cannot be removed.

To provide the access necessary to solve this problem, the image reading apparatus 310 according to this fourth embodiment of the invention provides a transportation path opening/closing mechanism 370 as further described below enabling a jammed first transported medium 2 to be easily removed.

The operation whereby the straight transportation path 313 conveys a second transported medium 15 is described next.

A card insertion opening 313a for inserting a second transported medium 15 to the straight transportation path 313 is provided on the right side of the image reading apparatus 310 as seen in FIG. 24.

A detector (not shown) for detecting insertion of a second transported medium 15 is disposed near the inside of the card insertion opening 313a. When a second transported medium 15 is inserted to the card insertion opening 313a and sensed by this detector, the detection signal triggers driving the transportation roller pair 316 and linear transportation roller pair 319. Similarly to the other transportation roller pairs, this linear transportation roller pair 319 has a feed roller 319a rotationally driven by a drive source (motor) not shown, and a pressure roller 319b (see FIG. 25A).

The second transported medium 15 is conveyed by transportation roller pair 316 and delivered into the transportation path 312. The second transported medium 15 is advanced until the trailing end thereof passes beyond the first image reader 324, and then stops. The second transported medium 15 is then transported in the opposite direction, both sides thereof are imaged as the second transported medium 15 passes the first image reader 324 and second image reader 326, and the second transported medium 15 is then externally discharged from the same card insertion opening 313a from which it was inserted.

To enable easily removing paper jams in the reading area where the first and second image readers 324, 326 and MICR head 328 are located, this image reading apparatus 310 has a transportation path opening/closing mechanism 370 including the above-described transportation path opening/closing block 330 and a roller opening/closing mechanism 350 linked to the opening/closing operation of the transportation path opening/closing block 330.

The transportation path opening/closing block 330 has the first image reader 324 and pressure mechanism 327 assembled to the inside of an opening/closing wall 331, which functions as the outside guide wall 312b of the U-shaped transportation path 312.

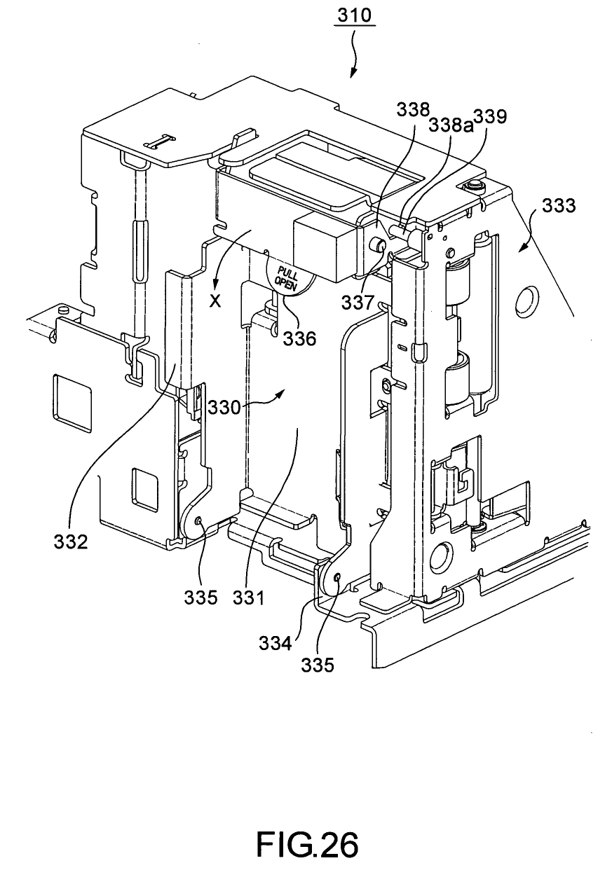

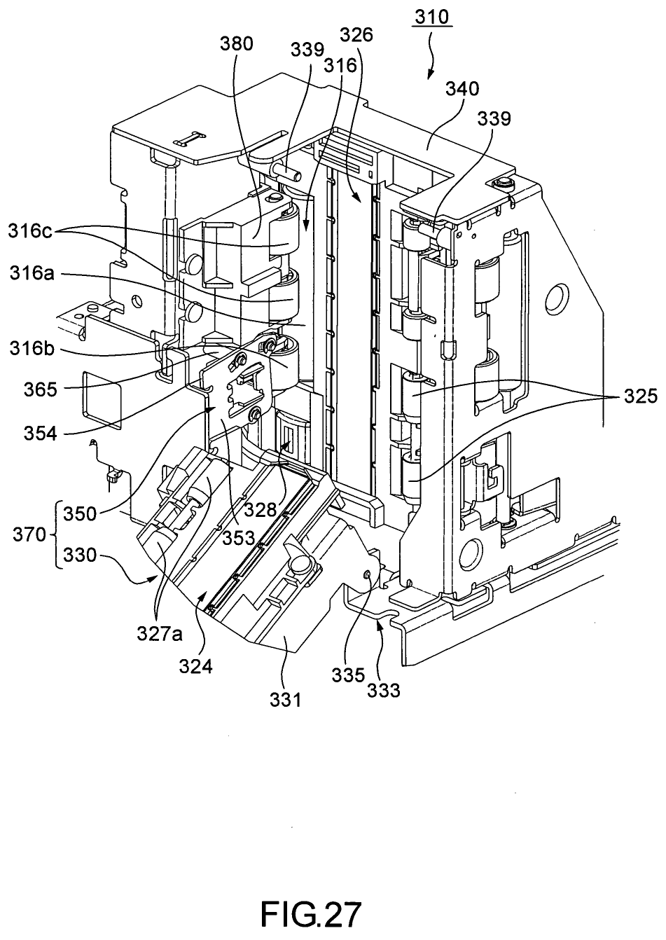

As shown in FIG. 26 and FIG. 27, the bottom of the opening/closing wall 331 of the transportation path opening/closing block 330 is pivotably connected via support pins 335 to the block support part 334 of the main frame 333 of the image reading apparatus 310. The opening/closing wall 331 can thus pivot on these support pins 335 and swing open to the outside as indicated by arrow X in FIG. 26.

A handle 336 that is held to open the transportation path opening/closing block 330 is provided at the top outside part of the opening/closing wall 331. When this handle 336 is pulled forward, hooks 338 disposed to both ends of the handle 336 move circularly around the support pins 337, and the engaging parts 338a on the ends of the hooks 338 disengage the catch pins 339 protruding from the main frame 333.

When the hooks 338 thus separate from the catch pins 339, the transportation path opening/closing block 330 is unlocked and can open outward in the direction of arrow X.

The hooks 338 are urged by a spring not shown in the direction engaging the catch pins 339. When the transportation path opening/closing block 330 is closed as shown in FIG. 26, the hooks 338 are locked engaged with the catch pins 339 by the urging force of the spring, and the transportation path opening/closing block 330 is thus prevented from opening accidentally.

The roller opening/closing mechanism 350 operates in conjunction with the opening/closing operation of the transportation path opening/closing block 330 so that the pressure rollers 316b, 317b move away from or closer to the corresponding feed rollers 316a, 317a.

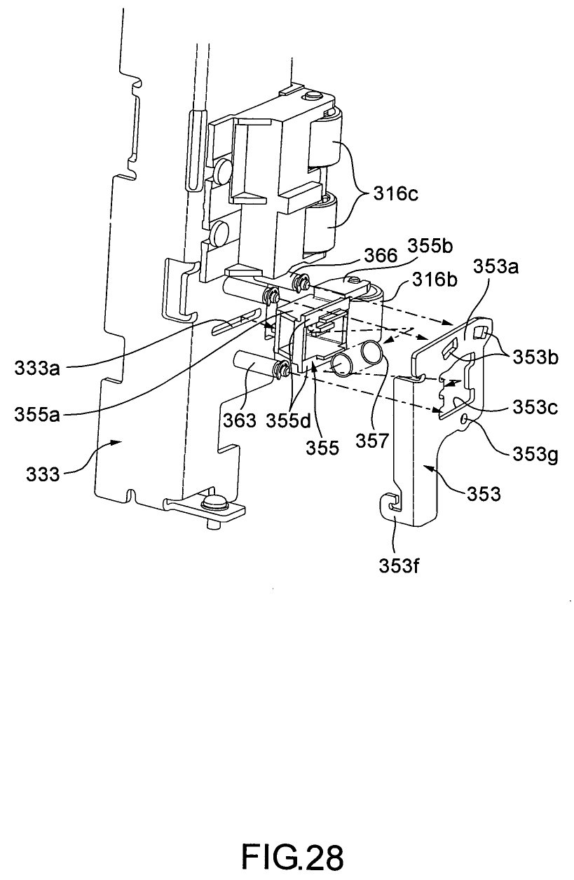

Operation of the roller opening/closing mechanism 350 is described next with reference to FIG. 28 to FIG. 31.

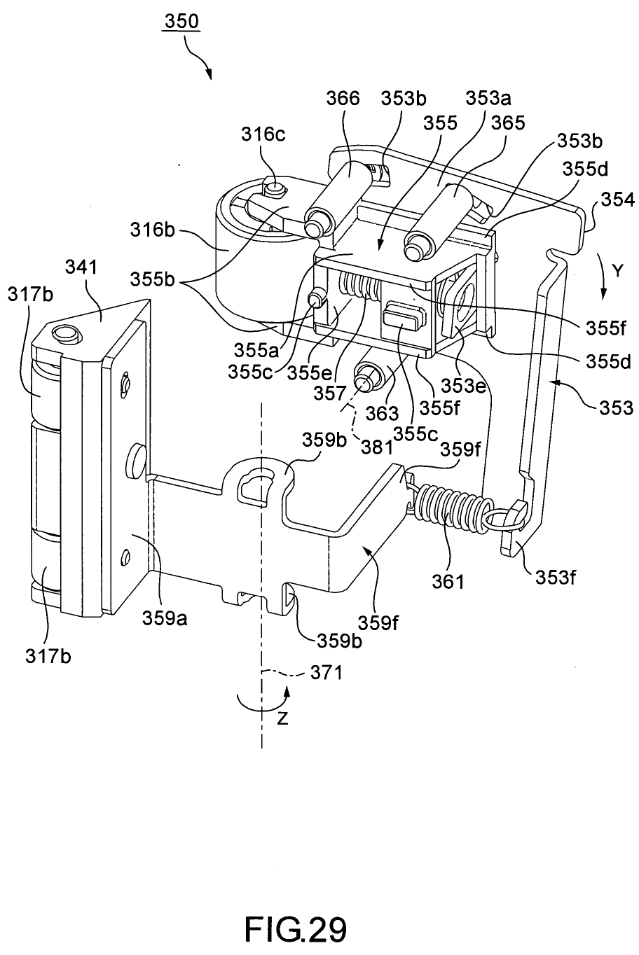

As shown in FIG. 28 and FIG. 29, the roller opening/closing mechanism 350 has a first pivot frame 353, first roller holding member 355, first roller urging spring 357, second roller holding member 341, second pivot frame 359, and second roller urging spring 361.

The first pivot frame 353 pivots in conjunction with the opening/closing operation of the transportation path opening/closing block 330. The first roller holding member 355 is disposed slidably to one pivoting end 353a of the first pivot frame 353, and holds the pressure roller 316b so that the pressure roller 316b can advance to and retract from the feed roller 316a of the transportation roller pair 316. The first roller urging spring 357 is connected between the first pivot frame 353 and the first roller holding member 355, and elastically urges the pressure roller 316b supported by the first roller holding member 355 to the feed roller 316a of the transportation roller pair 316.

The second roller holding member 341 holds a pair of pressure rollers 317b opposing the feed roller 317a of the transportation roller pair 317. The second roller holding member 341 is disposed to one pivot end 359a of the second pivot frame 359. The second roller urging spring 361 is attached to the other pivot end 353f of the first pivot frame 353 and the other pivot end 359f of the second pivot frame 359. The second roller urging spring 361 thus causes the second pivot frame 359 to rock circularly in conjunction with the circular movement of the first pivot frame 353, and elastically urges the pressure rollers 317b supported by the second roller holding member 341 to the feed roller 317a of the transportation roller pair 317.

The first pivot frame 353 is pivotably supported on the pivot shaft 363 of the main frame 333 through intervening support hole 353g formed in the middle of the first pivot frame 353 as shown in FIG. 28. Two support pins 365, 366 are used to attach the first pivot frame 353 to the main frame 333, but these two support pins 365, 366 engage respective long holes 353b formed in the first pivot frame 353, and thus do not interfere with the pivoting movement of the first pivot frame 353 around the rotational axis 381 of the pivot shaft 363.

As a result of the first pivot frame 353 pivoting on the pivot shaft 363 in conjunction with opening/closing the transportation path opening/closing block 330, the pivoting end 353a on which the pressure roller 316b is disposed is moved away from or closer to the feed roller 316a.

When the transportation path opening/closing block 330 is closed from the open position, the engaging part 332 disposed to the opening/closing wall 331 of the transportation path opening/closing block 330 engages the frame positioning surface 354 (see FIG. 29) on the one pivoting end 353a of the first pivot frame 353, thus pushing the first pivot frame 353 in the direction opposite arrow Y in FIG. 29 and returning the first pivot frame 353 to the closed position.

The first roller holding member 355 supports and allows the center shaft 316c of the pressure roller 316b to rotate freely by means of a pair of arms 355b extending forward from the main body 355a as shown in FIG. 29.

A pair of guide ribs 355c, and a pair of flanges 355f and 355d, are also disposed to the main body 355a of the first roller holding member 355. The guide ribs 355c are loosely fit so as to slide in a channel 333a formed in the main frame 333. The one flange 355f slides in contact with the surface of the main frame 333, and the other flange 355d slides in contact with the surface of the first pivot frame 353. As a result, the first roller holding member 355 supports the pressure roller 316b slidably to the feed roller 316a.

The first roller urging spring 357 in this fourth embodiment of the invention is a compression spring that is fit compressed between the spring bracket 353e of the first pivot frame 353, and the spring bracket 355e of the first roller holding member 355. This first roller urging spring 357 thus elastically urges the pressure roller 316b supported by the first roller holding member 355 to the feed roller 316a in unison with the first roller holding member 355.

As shown in FIG. 29, the second pivot frame 359 is supported freely rotatably to the main frame 333 by means of a shaft not shown passing through a pair of support members 359b formed in the middle part of the second pivot frame 359. The rotational axis 371 of this second pivot frame 359 intersects the rotational axis 381 of the first pivot frame 353.

The pivot end 359a to which the pressure rollers 317b are disposed moves away from and closer to the feed roller 317a of the transportation roller pair 317 as a result of the second pivot frame 359 moving circularly around the rotational axis 371 in conjunction with the circular movement of the first pivot frame 353.

The second roller urging spring 361 is an extension spring. To link the circular movement of the second pivot frame 359 causing the one pivot end 359a to move away from or closer to the feed roller 317a to the circular movement of the first pivot frame 353 causing the one pivoting end 353a to move away from or closer to the feed roller 316a, this second roller urging spring 361 elastically connects the other pivot end 353f of the first pivot frame 353 to the other pivot end 359f of the second pivot frame 359.

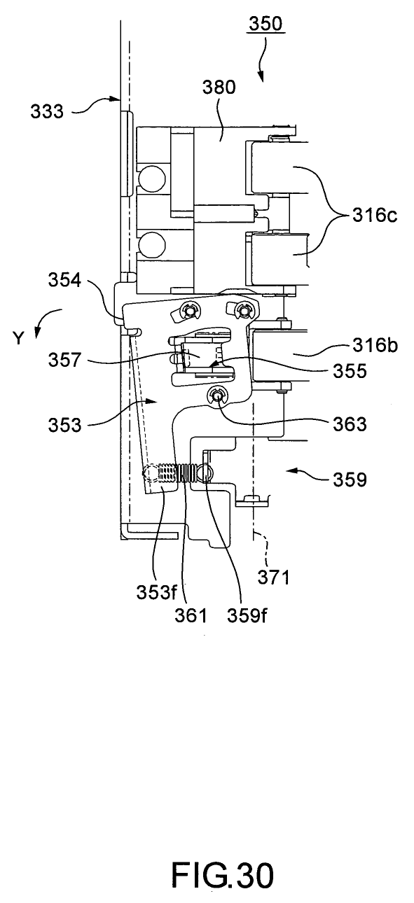

As shown in FIG. 30, the one pivoting end 353a of the first pivot frame 353 pivots in the direction of arrow Y on pivot shaft 363 in conjunction with the opening of the transportation path opening/closing block 330, thereby causing the pressure roller 316b to retract and move away from the feed roller 316a, and thus relieving the elastic urging force of the pressure roller 316b.

The one pivot end 359a of the second pivot frame 359 supporting the pressure rollers 317b moves circularly around the rotational axis 371 as shown by arrow Z in FIG. 29 at this time, and the elastic urging force of the pressure rollers 317b is thus also released.

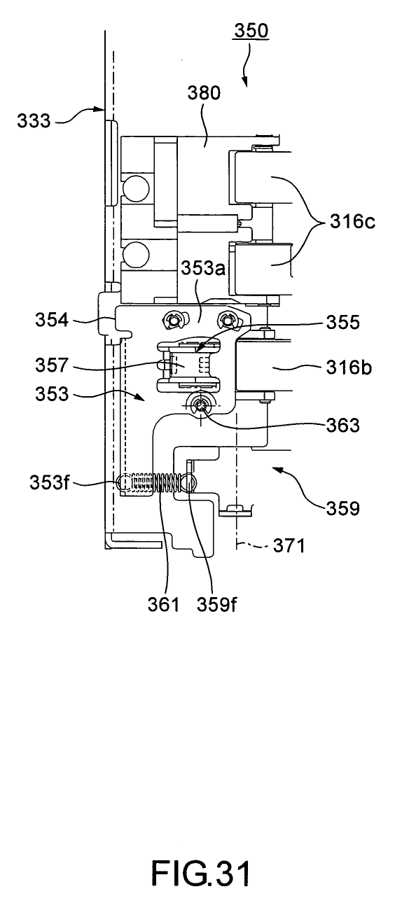

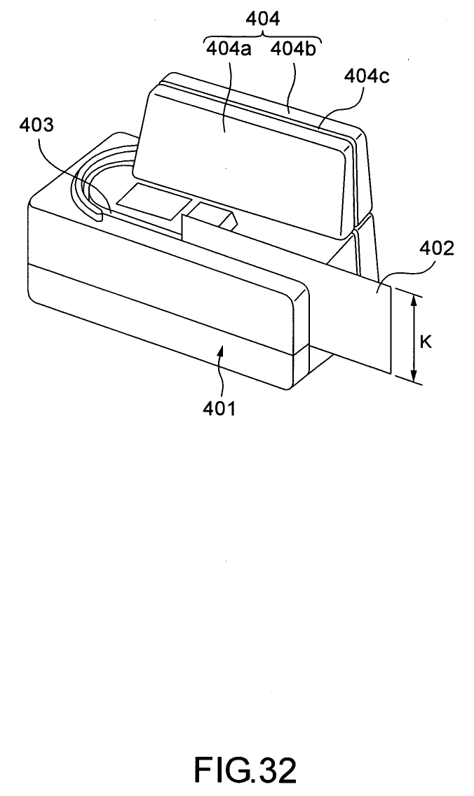

As shown in FIG. 31, when the transportation path opening/closing block 330 is returned to the closed position, the first pivot frame 353 also returns to the original position. At this time the frame positioning surface 354 of the first pivot frame 353 that is engaged by the engaging part 332 of the transportation path opening/closing block 330 is the point where the force returning the first pivot frame 353 to the original position acts. As a result, when the first pivot frame 353 rotates on the pivot shaft 363, the spring bracket 353e works to compress the first roller urging spring 357.

It will thus be apparent that by opening the transportation path opening/closing block 330 of the transportation path opening/closing mechanism 370 described above, all or part of a first transported medium 2 jammed in the transportation path can be externally exposed for access and removal.

If part of the jammed first transported medium 2 is held by a nearby transportation roller pair 316 or 317, and the transportation path opening/closing block 330 is opened to expose the paper jam, the action of the roller opening/closing mechanism 350 linked to opening the transportation path opening/closing block 330 retracts the pressure rollers 316b, 317b of the transportation roller pairs 316, 317 from the corresponding feed rollers 316a, 317a, and thus relieves or removes the holding force of the transportation rollers.

The jammed first transported medium 2 is thus exposed after the holding force of the transportation rollers 316, 317 is released, and the first transported medium 2 can be easily removed. Excess force is therefore also not needed to remove the first transported medium 2, and damage to the first transported medium 2 is thereby prevented.

Furthermore, when the transportation path opening/closing block 330 is closed after removing the paper jam, the action of the roller opening/closing mechanism 350 linked to closing the transportation path opening/closing block 330 elastically urges the pressure rollers 316b, 317b to the feed rollers 316a, 317a, and thus enables the transportation rollers to hold and transport the first transported medium 2.

Restoring the U-shaped transportation path 312 to the normal operating state after removing a paper jam is thus simple, and the time needed to correct and recover from a paper jam can be shortened.

Furthermore, moving the pressure rollers 316b, 317b from the feed rollers 316a, 317a in order to release the first transported medium 2 when a paper jam occurs is achieved by the pivoting action of the first and second pivot frames 353, 359 that support the pressure rollers 316b, 317b.

Compared with advancing and retracting the pressure rollers by means of linear movement, the present invention dependably maintains the positioning precision of the pressure rollers 316b, 317b by means of a simple mechanical configuration, and can easily adjust the pressure of the first and second roller urging springs 357, 361 that elastically urge the pressure rollers 316b, 317b to the feed rollers 316a, 317a.

As described above, the transportation path opening/closing mechanism 370 causes the second pivot frame 359 to pivot in conjunction with the circular movement of the first pivot frame 353 by means of the second roller urging spring 361 connected between the other pivot end 353f of the first pivot frame 353 and the other pivot end 359f of the second pivot frame 359, and elastically urges the pressure rollers 317b held by the second roller holding member 341 to the feed roller 317a by means of the second roller urging spring 361. This transportation path opening/closing mechanism 370 is thus well suited to arrangements in which the transportation rollers 316, 317 are located with the curved portion of the U-shaped transportation path 312 therebetween.

That is, by pivoting the second pivot frame 359 by means of a first pivot frame 353 that pivots in conjunction with the opening/closing operation of the transportation path opening/closing block 330, the pressure rollers 317b can be retracted away from the feed roller 317a and the holding force can be relieved or removed even though the second pivot frame 359 is separated from the transportation path opening/closing block 330 and the direction of the urging force of the spring is offset from the opening/closing direction.

The transportation path opening/closing block 330 is assembled to the main frame 333 so that the transportation path opening/closing block 330 can open and close by pivoting on support pins 335 parallel to the rotational axis 381 of the first pivot frame 353 at the bottom end of the transportation path opening/closing block 330. The transportation path opening/closing block 330 also has an engaging part 332 that engages a frame positioning surface 354 rendered to the one pivoting end 353a of the first pivot frame 353 when the transportation path opening/closing block 330 closes, and disengages the first pivot frame 353 when the transportation path opening/closing block 330 opens.

The transportation path opening/closing block 330 can thus swing freely open and closed like a door pivoting on pins at one end of the block 330, and part of the U-shaped transportation path 312 can be easily opened for access without any special training.

Furthermore, because the rotational axis 371 of the second pivot frame 359 intersects the rotational axis 381 of the first pivot frame 353, the pressure rollers 316b, 317b can apply appropriate elastic force to the corresponding feed rollers 316a, 317a even though the pressure roller 316b and pressure rollers 317b apply elastic force in different directions and positions.

The configuration of the pressure rollers, including the arrangement and number of rollers, for which the roller opening/closing mechanism of the foregoing embodiment removes or relieves pressure in order to correct a paper jam shall not be limited to the configuration of the above embodiment.

In the foregoing embodiment, for example, the transportation roller set 316 located in the image scanning area of the U-shaped transportation path 312 has three pressure rollers 316b and 316c stacked heightwise to the feed roller 316a (that is, heightwise to the U-shaped transportation path 312).

In addition, the first pivot frame 353 of the roller opening/closing mechanism 350 in this embodiment movably supports only the lowest pressure roller 316b, and the two upper pressure rollers 316c are supported by the stationary frame 380.

This is because the top two pressure rollers 316c are used for transporting an ID card or other second transported medium 15 inserted from the card insertion opening 313a to the straight transportation path 313, and only the lowest pressure roller 316b is used for conveying checks or other first transported medium 2.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. An information processing apparatus comprising:
a U-shaped transportation path for conveying a first transported medium;
a data reader for reading information recorded to the first transported medium conveyed on the U-shaped transportation path; and
a transportation path opening/closing mechanism disposed along the U-shaped transportation path in the area where the data reader is disposed to the U-shaped transportation path with the transportation path opening/closing mechanism having an open and closed position wherein in said open position said U-shaped transportation path adjacent said data reader is exposed to provide access to said first transported medium.

2. The apparatus of claim 1, further comprising a straight transportation path including a straight portion of the U-shaped transportation path containing the area where the data reader and transportation path opening/closing mechanism are disposed, and a linear transportation path connected in line with said straight portion,
said straight transportation path conveying a second transported medium for reading information recorded on the second transported medium by means of the data reader.

3. The apparatus of claim 2, wherein the U-shaped transportation path comprises an outside guide wall and an inside guide wall for guiding the first or second transported medium on both sides of the transported medium; and
wherein the transportation path opening/closing mechanism comprises an opening/closing wall that can open and close to the transportation path on the side thereof adjacent at least one of the outside and inside guide walls.

4. The apparatus of claim 3, wherein the information processing apparatus has a frame with said opening/closing wall having a pivot joint pivotally connected to the frame of the information processing apparatus for opening and closing said wall.

5. The apparatus of claim 4, further comprising a pressure mechanism for pressing the first or second transported medium to the scanning surface of the data reader wherein said data reader or said pressure mechanism is attached to the opening/closing wall.

6. The apparatus of claim 2, further comprising at least one transportation roller pair for conveying the first or second transported medium and for holding the first or second transported medium even when the U-shaped transportation path is open.

7. The apparatus of claim 3, further comprising at least one transportation roller pair for conveying the first or second transported medium and for holding the first or second transported medium even when the U-shaped transportation path is open.

8. The apparatus of claim 5, further comprising at least one transportation roller pair for conveying the first or second transported medium and for holding the first or second transported medium even when the U-shaped transportation path is open.

9. The apparatus of claim 3 further comprising:
a first data reader disposed on the outside guide wall side of the transportation path for reading information on one side of the first or second transported medium;
a first pressure mechanism disposed on the inside guide wall side opposite the first data reader for pressing the first or second transported medium to the scanning surface of the first data reader;
a second data reader disposed on the inside guide wall side of the transportation path for reading information on the other side of the first or second transported medium; and
a second pressure mechanism disposed on the outside guide wall side opposite the second data reader for pressing the first or second transported medium to the scanning surface of the second data reader;
wherein the first data reader and the second pressure mechanism are attached to the opening/closing wall.

10. The apparatus of claim 7 further comprising:
a first data reader disposed on the outside guide wall side of the transportation path for reading information on one side of the first or second transported medium;
a first pressure mechanism disposed on the inside guide wall side opposite the first data reader for pressing the first or second transported medium to the scanning surface of the first data reader;
a second data reader disposed on the inside guide wall side of the transportation path for reading information on the other side of the first or second transported medium; and
a second pressure mechanism disposed on the outside guide wall side opposite the second data reader for pressing the first or second transported medium to the scanning surface of the second data reader;
wherein the first data reader and the second pressure mechanism are attached to the opening/closing wall.

11. An information processing apparatus comprising:
a transportation path having a top portion for conveying a transported medium standing lengthwise on edge along a horizontal surface with the top portion of the transportation path exposed to the outside of the information processing apparatus;
a data reader disposed to the transportation path for reading information on the transported medium conveyed through the transportation path; and
a cover member for covering at least part of said top portion of the transportation path in the area where the data reader is disposed to the transportation path.

12. The apparatus of claim 11, wherein the transportation path has a portion wherein the transported medium is conveyed with a part of the transported medium exposed from the transportation path, and a portion wherein the entire transported medium is covered; and
the cover member covers at least a portion of said top portion of the transportation path in the area where the transported medium is completely covered.

13. The apparatus of claim 12, wherein the transportation path is formed in a U-shape resulting in the transported medium being conveyed in substantially opposite directions at the insertion opening and discharge opening.

14. The apparatus of claim 13, wherein the U-shaped transportation path comprises an outside guide wall and an inside guide wall for guiding the first or second transported medium on both sides of the transported medium and wherein the cover member is fastened to the inside guide wall and outside guide wall of the transportation path, and holds a gap between said guide walls to a specific width.

15. The apparatus of claim 14, wherein the cover member engages engagement pins disposed to one of the guide walls, and is fastened by screw to the other guide wall.

16. The apparatus of claim 11 further comprising a transportation path opening/closing mechanism disposed to the area where the data reader is disposed to the transportation path and having an open position and a closed position for opening/closing respectively a portion of the transportation path adjacent the data reader;
wherein the cover member closes at least the portion of the transportation path opened when the transportation path opening/closing mechanism is in the open position.

17. The apparatus of claim 14 further comprising a transportation path opening/closing mechanism disposed to the area where the data reader is disposed to the transportation path and having an open position and a closed position for opening/closing respectively a portion of the transportation path adjacent the data reader;
wherein the cover member closes at least the portion of the transportation path opened when the transportation path opening/closing mechanism is in the open position.

18. The apparatus of claim 17, wherein the cover member has a positioning groove for controlling the closed position of the transportation path opening/closing mechanism; and
wherein the transportation path opening/closing mechanism engages the positioning groove in the closed position to control the closed position of the transportation path opening/closing mechanism.

19. The apparatus of claim 16 wherein the data reader includes one or both of an image scanner for imaging the transported medium, and a magnetic ink character reader for reading magnetic ink characters on the transported medium.

20. The apparatus of claim 19, further comprising a data recording unit disposed to a portion of the transportation path for recording information to the transported medium.

21. A transportation path opening/closing mechanism for use in an information processing apparatus having a U-shaped transportation path for conveying a first transported medium comprising:
a data reader disposed to the U-shaped transportation path for reading information recorded to the first transported medium;
a transportation path opening/closing block for opening/closing a portion of the U-shaped transportation path in the area where the data reader is disposed to the U-shaped transportation path to provide access to the first medium;
transportation rollers disposed to the U-shaped transportation path at a position other than where the data reader is disposed for conveying the transported medium by means of a feed roller and pressure roller that rotate holding the transported medium; and
a roller pressure block for reducing the pressure load on the pressure roller when the transportation path opening/closing block is open, and applying a specific elastic load to the pressure roller when the transportation path opening/closing block is in the closed position, in conjunction with opening/closing the transportation path opening/closing block.

22. The mechanism of claim 21, wherein the transportation path opening/closing block is attached at one end thereof to the main frame by means of a pivot joint enabling the transportation path opening/closing block to rotate open and closed on the pivot joint.

23. The mechanism of claim 22, wherein the transportation path opening/closing block comprises a pressure engaging portion that engages the roller pressure block and applies pressure to the pressure roller by means of an intervening elastic member disposed to the roller pressure block when the transportation path opening/closing block is in the closed position, and disengages the roller pressure block when the transportation path opening/closing block is opened.

24. The mechanism of claim 23, wherein the roller pressure block comprises a roller holding member that holds the pressure roller and can slide in the feed roller direction, and a pressure frame for urging and pressing the roller holding member in the feed roller direction by means of the intervening elastic member;
wherein the pressure engaging portion engages the pressure frame when the transportation path opening/closing block is closed, and pushes and urges the roller holding member in the feed roller direction by means of the intervening elastic member.

25. The mechanism of claim 24, wherein a single pressure frame pushes and urges a plurality of roller holding members.

26. The mechanism of claim 25 , wherein the pressure frame is held slidably to the main frame, and the roller holding member is held slidably to the pressure frame.

27. The mechanism of claim 25, wherein the roller holding member is held slidably to the main frame, and the pressure frame is held slidably to the roller holding member.

28. The mechanism of claim 25, wherein the roller holding member and pressure frame are both held independently slidably to the main frame.

29. A transportation path opening/closing mechanism for use in an information processing apparatus having a U-shaped transportation path for conveying a first transported medium comprising:
a data reader disposed to the U-shaped transportation path for reading information recorded to the transported medium;
a transportation path opening/closing block for opening/closing a portion of the U-shaped transportation path in the area where the data reader is disposed to the U-shaped transportation path;
first transportation rollers disposed to the U-shaped transportation path at a position other than where the data reader is disposed for conveying the transported medium by means of a feed roller and pressure roller that rotate holding the transported medium; and
a roller opening/closing block comprising a pivot arm that pivots in conjunction with opening/closing of the transportation path opening/closing block, and a roller pressure arm of which one end is linked to the pivot arm by means of an elastic member and the other end holds the pressure roller,
the roller opening/closing block adjusts the pressure load of the pressure roller on the feed roller by increasing or decreasing the elastic load of the roller pressure arm by means of the elastic member according to the pivoting motion of the pivot arm.

30. The mechanism of claim 29, wherein the transportation path opening/closing block is attached at one end thereof to the main frame of the information processing apparatus by means of a pivot joint enabling the transportation path opening/closing block to rotate open and closed on the pivot joint.

31. The mechanism of claim 30, wherein the transportation path opening/closing block comprises a pivoting engagement part that engages one end of the pivot arm when closed and disengages the pivot arm when opened.

32. The mechanism of claim 31, wherein the elastic member is an elastic member of which one end engages the roller pressure arm and the other end engages the pivot arm; and
the pivoting engagement part causes the pivot arm to rotate in the direction causing the elastic load of the elastic member to increase the pressure load of the pressure roller when the transportation path opening/closing block closes.

33. The mechanism of claim 32, wherein the roller pressure arm can move circularly around a rotary shaft; and
the elastic member is an extension spring of which one end is attached to the roller pressure arm and the other end is attached to the pivot arm.

34. The mechanism of claim 29, wherein the first transportation rollers are disposed adjacent to a curved portion of the U-shaped transportation path between the first transportation rollers and the transportation path opening/closing block.

35. The mechanism of claim 34, wherein to reduce the holding force of second transportation rollers located on the opposite side of the transportation path opening/closing block as the first transportation rollers, the transportation path opening/closing mechanism further comprises:
a roller pressure block for applying an elastic load of specific strength to the pressure roller of the second transportation rollers when the transportation path opening/closing block is in the closed position, and reducing the pressure load of said pressure roller when the transportation path opening/closing block is opened, in conjunction with opening/closing the transportation path opening/closing block.

36. The mechanism of claim 35, wherein the transportation path opening/closing block comprises a pressure engaging portion that engages the roller pressure block and applies pressure to the pressure roller of the second transportation rollers by means of an intervening elastic member disposed to the roller pressure block when the transportation path opening/closing block is in the closed position, and disengages the roller pressure block of the second transportation rollers when the transportation path opening/closing block is opened.

37. The mechanism of claim 36, wherein the roller pressure block comprises a roller holding member that holds the pressure roller of the second transportation rollers and can slide said pressure roller in the direction of the feed roller of the second transportation rollers, and a pressure frame for urging and pressing the roller holding member in the direction of the feed roller of the second transportation rollers by means of the intervening elastic member;
wherein the pressure engaging portion engages the pressure frame when the transportation path opening/closing block is closed, and pushes and urges the roller holding member in the direction of the feed roller of the second transportation rollers by means of the intervening elastic member.

38. The mechanism of claim 21, wherein the data reader includes one or both of an image scanner for imaging the transported medium, and a magnetic ink character reader for reading magnetic ink characters on the transported medium.

39. The mechanism of claim 29, wherein the data reader includes one or both of an image scanner for imaging the transported medium, and a magnetic ink character reader for reading magnetic ink characters on the transported medium.

40. The mechanism of claim 38, further comprising a data recording unit disposed to a portion of the transportation path for recording information to the transported medium.

41. The mechanism of claim 39, further comprising a data recording unit disposed to a portion of the transportation path for recording information to the transported medium.

42. A transportation path opening/closing mechanism comprising first and second transportation roller pairs disposed to a transportation path for conveying a transported medium and each having a rotationally driven feed roller and a pressure roller for pressing the transported medium to the feed roller, a transportation path opening/closing block for opening/closing a portion of the transportation path, and a roller opening/closing mechanism for advancing and retracting the pressure rollers of the first and second transportation roller pairs in the direction separating from the corresponding feed rollers in conjunction with opening/closing the transportation path opening/closing block, wherein:
the roller opening/closing mechanism comprises:
a first pivot frame that moves circularly in conjunction with opening/closing the transportation path opening/closing block;
a first roller holding member disposed slidably to one pivoting end of the first pivot frame, and holding the pressure roller to advance to and retract from the feed roller of the first transportation roller pair;
a first roller urging spring mounted between the first pivot frame and first roller holding member for elastically urging the pressure roller held by the first roller holding member toward the feed roller of the first transportation roller pair;
a second roller holding member for holding a pressure roller opposite the feed roller of the second transportation roller pair;
a second pivot frame to which the second roller holding member is disposed on one end thereof; and
a second roller urging spring mounted between the other pivoting end of the first pivot frame and the other pivoting end of the second pivot frame, and causing the second pivot frame to move circularly and elastically urging the pressure roller held by the second roller holding member in the direction of the feed roller of the second transportation roller pair in conjunction with the circular movement of the first pivot frame.

43. The mechanism of claim 42, wherein the transportation path opening/closing block is assembled openably and closably to the main frame with one end thereof functioning as a pivot axis that is parallel to the rotational axis of the first pivot frame, and the transportation path opening/closing block comprises an engaging part that engages one pivoting end of the first pivot frame when closing, and separates from the first pivot frame when open.

44. The mechanism of claim 42, wherein the rotational axis of the second pivot frame intersects the rotational axis of the first pivot frame.

45. The mechanism of claim 42, wherein the transportation path is substantially U-shaped with two curved portions, the first and second transportation roller pairs are disposed with the curved portion on the downstream side of the transportation path between the first and second transportation roller pairs, and the transportation path opening/closing block is disposed adjacent to the upstream side of the first transportation roller pair.

46. The mechanism of claim 45, further comprising in a portion of the transportation path at least one of a data reader for reading information on the transported medium, and a data recorder for recording information on the transported medium.

47. An information processing apparatus comprising:
a first transportation path for conveying a first medium;
an information processing unit disposed along the first transportation path for reading and/or writing information on the first medium;
an opening/closing mechanism for opening and closing a specific area of the first transportation path for providing access to the first medium external of the information processing apparatus including the area where the information processing unit is disposed;
a first transportation roller pair disposed adjacent to said specific area for conveying the first medium, and including a drive roller and a pressure roller for pressing the first medium to the drive roller; and
a pressure adjusting mechanism that in conjunction with opening/closing the opening/closing mechanism applies a specific load to the pressure roller when the specific area of the first transportation path is closed, and releases or reduces the specific load on the pressure roller when the specific area of the transportation path is open.

48. The apparatus of claim 47, further comprising:
a roller support frame for supporting the pressure roller;
a slide frame disposed slidably to the roller support frame; and
an elastic member mounted between the roller support frame and slide frame for applying elastic force to the pressure roller;
wherein when the specific area of the first transportation path changes from the open position to the closed position in conjunction with the closing operation of the opening/closing mechanism, the elastic force of the elastic member increases and the specific load is applied to the pressure roller as a result of the contact part of the opening/closing mechanism contacting the slide frame and causing the slide frame to slide.

49. The apparatus of claim 48, further comprising:
a roller support member having a support portion for supporting the pressure roller formed on one end portion, and a catch portion for holding an elastic member formed on the other end portion, and disposed pivotably at a center of rotation between the support portion and the catch portion; and
a lever member having a lever contact portion for contacting the contact part of the opening/closing mechanism formed on one end portion of the lever member, and a lever catch portion for holding the elastic member formed on the other end portion of the lever member, and disposed pivotably at a center of rotation between the lever contact portion and the lever catch portion;
wherein when the specific area of the first transportation path changes from the open position to the closed position in conjunction with the closing operation of the opening/closing mechanism, the elastic force of the elastic member increases and the specific load is applied to the pressure roller as a result of the contact part of the opening/closing mechanism contacting the lever contact portion of the lever member and causing the lever member to pivot.

50. The apparatus of claim 47, further comprising:
a roller support frame for supporting the pressure roller;
a first roller support member having formed at one end portion thereof a support portion for supporting the roller support frame movably, and a catch portion formed at the other end portion thereof for holding one end of an elastic member, and disposed pivotably in a first direction at a center of rotation between the support portion and the catch portion;
a second transportation roller pair including a second drive roller and a second pressure roller disposed in proximity to the first transportation roller pair; and
a second roller support member having formed at one end portion thereof a second support portion for supporting the second pressure roller, and a second catch portion formed on the other end portion thereof for holding the other end of the elastic member, and disposed pivotably in a second direction at a center of rotation between the second support portion and the second catch portion,
said second direction being substantially perpendicular to the first direction;
wherein when the specific area of the first transportation path changes from the open position to the closed position in conjunction with the closing operation of the opening/closing mechanism, the second roller support member pivots, the elastic force of the elastic member increases, and the specific load is applied to the second pressure roller as a result of the contact part of the opening/closing mechanism contacting a contact portion of the first roller support member and causing the first roller support member to pivot.
